(19) United States
(12) Patent Application Publication
(10) Pub. No.: US 2025/0364586 A1
(43) Pub. Date: Nov. 27, 2025

(54) ELECTRODE FOR A BATTERY

(71) Applicant: Rutgers, The State University of New Jersey, New Brunswick, NJ (US)

(72) Inventors: Glenn G. Amatucci, Peapack, NJ (US); Emily Sukenik, New Brunswick, NJ (US)

(21) Appl. No.: 19/295,104

(22) Filed: Aug. 8, 2025

Related U.S. Application Data
(63) Continuation of application No. PCT/US2024/015151, filed on Feb. 9, 2024.
(60) Provisional application No. 63/444,358, filed on Feb. 9, 2023.

(51) Int. Cl. H01M 10/0525; H01M 4/02; H01M 4/04; H01M 10/058

(52) U.S. Cl. CPC H01M 10/0525; H01M 4/0404; H01M 10/058; H01M 2004/021

(57) ABSTRACT

A battery including a housing; an electrolyte disposed in the housing; and a first electrode, wherein a porosity of the first electrode varies across a surface of the first electrode. A method includes obtaining a first electrode having a first predetermined porosity, obtaining a second electrode having a second predetermined porosity, wherein the second predetermined porosity is different than the first predetermined porosity, and laminating the first electrode with the second electrode, thereby to provide for an interface free electrode structure with a porosity gradient.

### CROSS-REFERENCE TO RELATED APPLICATIONS

This application is a Continuation Application relating to and claiming the benefit commonly-owned, co-pending PCT International Application No. of PCT/US2024/015151, titled “ELECTRODE FOR A BATTERY,” filed Feb. 9, 2024, which claims priority to and the benefit of U.S. Provisional Patent Application No. 63/444,358, titled “ELECTRODE FOR A BATTERY,” filed Feb. 9, 2023, the contents of each of the forgoing is incorporated by reference herein in its entirety.

### FIELD

The present invention relates to a battery, and, more particularly, to an electrode for a battery.

### BACKGROUND

A known electrochemical battery, such as a lithium battery, includes two electrodes-a cathode, and an anode.

### SUMMARY

The Claims, rather than the Summary, define covered embodiments of the present invention. The Summary is a high-level overview of various aspects of the invention, and introduces some concepts that are further described in the Detailed Description below. The Summary is not intended to identify key or essential features of the claimed subject matter, and also is not intended to be used in isolation to determine the scope of the claimed subject matter. Instead, the claimed subject matter should be understood by reference to appropriate portions of the Specification and drawings, as well as each claim. In some embodiments, a battery includes a housing; an electrolyte disposed in the housing; and a first electrode, wherein a first porosity of the first electrode varies across a first surface of the first electrode.

In some embodiments, the first porosity of the first electrode varies in a gradient across the first surface. In some embodiments, the first electrode is a positive electrode or a negative electrode.

In some embodiments, the battery further includes a second electrode, wherein a second porosity of the second electrode varies in a gradient across a second surface of the second electrode. In some embodiments, the first electrode includes a plurality of first electrode layers, and wherein the first porosity of each of the plurality of first electrode layers is different from one another. In some embodiments, each of the plurality of first electrode layers is laminated to one another.

In some embodiments, the battery further includes an electronically insulating layer disposed in the housing and containing the electrolyte. In some embodiments, the first electrode and the second electrode are stacked vertically, wherein the electronically insulating layer is interposed between the first electrode and the second electrode, wherein the electrolyte resides in at least one of the first porosity of the first electrode and the second porosity of the second electrode, and wherein at least one of the first porosity of the first electrode and the second porosity of the second electrode varies laterally across the first surface of the first electrode and the second surface of the second electrode. In some embodiments, the first electrode is bonded to the electronically insulating layer.

In some embodiments, the first electrode includes a positive electrode, wherein the second electrode includes a negative electrode, wherein at least one of: the first porosity varies through a thickness of the first electrode, the second porosity varies through a thickness of the second electrode, and wherein at least one of an average porosity of the first porosity of the first electrode increases towards an interface of the first electrode and the electronically insulating layer, and an average porosity of the second porosity of the second electrode increases towards an interface of the second electrode and the electronically insulating layer which contains the electrolyte.

In some embodiments, the plurality of first electrode layers includes at least a first electrode layer and a second electrode layer, wherein the first electrode layer has a higher porosity than the second electrode layer, wherein the first electrode layer is bonded to the second electrode layer, and wherein the first electrode layer is closer to an interface of the first electrode with the electrolyte.

In some embodiments, the second electrode includes a plurality of second electrode layers, wherein the plurality of second electrode layers includes at least a third electrode layer and a fourth electrode layer, wherein the third electrode layer has a higher porosity than the fourth electrode layer, wherein the third electrode layer is bonded to the fourth electrode layer, wherein the third electrode layer is closer to the interface of the second electrode with the electrolyte. In some embodiments, the first electrode includes a negative or positive active electrode material, a conductive additive, a binder, and a plasticizer.

In some embodiments, a battery includes at least one current collector; at least one current collector tab; a positive electrode; and a negative electrode, wherein each of the positive electrode and the negative electrode has a porosity, wherein a maximum porosity of the porosity of at least one of the positive electrode and the negative electrode is formed laterally closest to the at least one current collector tab, and wherein the maximum porosity decreases systematically away from the at least one current collector.

In some embodiments, at least one of the positive electrode and the negative electrode includes a plurality of electrode layers, and wherein the porosity of each of the plurality of electrode layers is different from one another. In some embodiments, the plurality of electrode layers are laminated to one another.

In some embodiments, the plurality of electrode layers includes a first electrode layer, a second electrode layer, and a third electrode layer, wherein the second electrode layer is between the first electrode layer and the third electrode layer, wherein the porosity of the first electrode layer is greater than the porosity of the second electrode layer, and wherein the porosity of the second electrode layer is greater than the porosity of the third electrode layer.

In some embodiments, a method includes obtaining a first electrode having a first predetermined porosity; obtaining a second electrode having a second predetermined porosity, wherein the second predetermined porosity is different than the first predetermined porosity; and laminating the first electrode with the second electrode to provide an electrode structure with a porosity gradient.

In some embodiments, at least one of the first electrode and the second electrode includes a plasticizer, and wherein the method further comprises extracting the plasticizer to leave the electrode structure with the porosity gradient. In some embodiments, the method further includes laminating the electrode structure to at least one of a current collector and an electronically insulating layer.

### BRIEF DESCRIPTION OF THE DRAWINGS

This section refers to the drawings that form a part of this disclosure, and which illustrate some of the embodiments of structure, materials, and/or methods of the present invention described herein.

FIG. 1 is a schematic representing porosity and thickness of layers of a laminated gradient electrode, in accordance with some embodiments of the invention.

FIG. 2A is a circuit model used to fit the Electrochemical Impedance Spectroscopy (EIS) spectrums of symmetric electrode cells with completely linear 45° lines in representative Cole-Cole impedance plots, in accordance with some embodiments of the invention.

FIG. 2B is a circuit model used to fit the EIS spectrums with variation in 45° lines, in representative Cole-Cole impedance plots in accordance with some embodiments of the invention.

FIG. 3 is cross sections of 16% (a), 34% (b), and 48% (c) porosity LiCoO2 (LCO) electrodes taken with digital optical microscope, in accordance with some embodiments of the invention.

FIG. 4A is cross sections of 16% (a), 34% (b), and 48% (c) porosity LCO electrodes imaged with a He ion microscope at 50 μm field of view and 5 μm scalebar, in accordance with some embodiments of the invention.

FIG. 4B is a cross section of a carbon network of 16% porosity LCO electrode, imaged with a He ion microscope at 2.5 μm field of view and 200 nm scalebar (a) and 1 μm field of view and 100 nm scalebar (b), in accordance with some embodiments of the invention.

FIG. 5 is a graph showing BET results of single layer 16%, 34%, and 48% porosity electrodes, in accordance with some embodiments of the invention.

FIG. 6A is a bar graph of Cumulative Capacity Density vs. Rate for signature discharge curves for electrodes of ˜230 μm thickness, in accordance with some embodiments of the invention.

FIG. 6B is bar graph of areal capacity (mAh/cm²) vs. rate for full discharges of ˜230 μm thick electrodes, in accordance with some embodiments of the invention.

FIG. 7A is a bar graph of Capacity Density vs. Rate for full discharges at various rates for electrodes of ˜230 μm thickness, in accordance with some embodiments of the invention.

FIG. 7B is a graph of voltage profiles at 1 C full discharge for electrodes of ˜230 μm thickness, in accordance with some embodiments of the invention.

FIG. 7C is a graph of voltage profiles at C/10 full discharge for all electrodes of ˜230 μm thickness, in accordance with some embodiments of the invention.

FIG. 8A is a cross section of a gradient porosity electrode imaged with a digital optical microscope at ×700 magnification, in accordance with some embodiments of the invention.

FIG. 8B is a cross section of the gradient porosity electrode imaged with digital optical microscope at ×1500 magnification, in accordance with some embodiments of the invention.

FIG. 9 is a correlation plot of Tortuosity vs BET Porosity for 16%, 34% and 48% porosity electrodes, in accordance with some embodiments of the invention.

### DETAILED DESCRIPTION

In addition to the benefits and improvements that the Specification discloses, other objects and advantages of that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

Throughout the specification and claims, the following terms take the meanings explicitly associated herein, unless the context clearly dictates otherwise. The phrases “in an embodiment,” “in some embodiments,” and any similar phrase, as used herein, do not necessarily refer to the same embodiment or embodiments, though the phrases may refer to the same embodiment or embodiments. Furthermore, the phrases “in another embodiment,” and any similar phrase, as used herein, do not necessarily refer to a different embodiment, although the phrases may refer to a different embodiment. All embodiments of the disclosure are intended to be combinable without departing from the scope or spirit of the disclosure.

As used herein, terms such as “comprising,” “including,” “having,” and any similar phrase, do not limit the scope of a specific claim to the materials or steps recited by the claim.

In some embodiments, the present invention provides an electrode for a battery, the electrode having a porosity that varies in a gradient.

In some embodiments, the present invention provides an electrode with a porosity that varies continuously in a gradient.

In some embodiments, the present invention provides an electrode with a porosity that varies continuously from a higher percentage to a lower percentage.

In some embodiments, the present invention provide an electrode with a porosity that various continuously from a lower percentage to a higher percentage.

In some embodiments, the present invention provides an electrode with a porosity having a lower percentage of 0%. In some embodiments, the present invention provides an electrode with a porosity having a lower percentage of 1%. In some embodiments, the present invention provides an electrode with a porosity having a lower percentage of 2%. In some embodiments, the present invention provides an electrode with a porosity having a lower percentage of 3%. In some embodiments, the present invention provides an electrode with a porosity having a lower percentage of 4%. In some embodiments, the present invention provides an electrode with a porosity having a lower percentage of 5%. In some embodiments, the present invention provides an electrode with a porosity having a lower percentage of 10%. In some embodiments, the present invention provides an electrode with a porosity having a lower percentage of 15%. In some embodiments, the present invention provides an electrode with a porosity having a lower percentage of 20%. In some embodiments, the present invention provides an electrode with a porosity having a lower percentage of 25%. In some embodiments, the present invention provides an electrode with a porosity having a lower percentage of 30%. In some embodiments, the present invention provides an electrode with a porosity having a lower percentage of 35%. In some embodiments, the present invention provides an electrode with a porosity having a lower percentage of 40%. In some embodiments, the present invention provides an electrode with a porosity having a lower percentage of 45%. In some embodiments, the present invention provides an electrode with a porosity having a lower percentage of 50%. In some embodiments, the present invention provides an electrode with a porosity having a lower percentage of 55%. In some embodiments, the present invention provides an electrode with a porosity having a lower percentage of 60%.

In some embodiments, the present invention provides an electrode with a porosity having a lower percentage less than 1%. In some embodiments, the present invention provides an electrode with a porosity having a lower percentage less than 2%. In some embodiments, the present invention provides an electrode with a porosity having a lower percentage less than 3%. In some embodiments, the present invention provides an electrode with a porosity having a lower percentage less than 4%. In some embodiments, the present invention provides an electrode with a porosity having a lower percentage less than 5%. In some embodiments, the present invention provides an electrode with a porosity having a lower percentage less than 10%. In some embodiments, the present invention provides an electrode with a porosity having a lower percentage less than 15%. In some embodiments, the present invention provides an electrode with a porosity having a lower percentage less than 20%. In some embodiments, the present invention provides an electrode with a porosity having a lower percentage less than 25%. In some embodiments, the present invention provides an electrode with a porosity having a lower percentage less than 30%. In some embodiments, the present invention provides an electrode with a porosity having a lower percentage less than 35%. In some embodiments, the present invention provides an electrode with a porosity having a lower percentage less than 40%. In some embodiments, the present invention provides an electrode with a porosity having a lower percentage less than 45%. In some embodiments, the present invention provides an electrode with a porosity having a lower percentage less than 50%. In some embodiments, the present invention provides an electrode with a porosity having a lower percentage less than 55%. In some embodiments, the present invention provides an electrode with a porosity having a lower percentage less than 60%.

In some embodiments, the present invention provides an electrode with a porosity having a lower percentage greater than 1%. In some embodiments, the present invention provides an electrode with a porosity having a lower percentage greater than 2%. In some embodiments, the present invention provides an electrode with a porosity having a lower percentage greater than 3%. In some embodiments, the present invention provides an electrode with a porosity having a lower percentage greater than 4%. In some embodiments, the present invention provides an electrode with a porosity having a lower percentage greater than 5%. In some embodiments, the present invention provides an electrode with a porosity having a lower percentage greater than 10%. In some embodiments, the present invention provides an electrode with a porosity having a lower percentage greater than 15%. In some embodiments, the present invention provides an electrode with a porosity having a lower percentage greater than 20%. In some embodiments, the present invention provides an electrode with a porosity having a lower percentage greater than 25%. In some embodiments, the present invention provides an electrode with a porosity having a lower percentage greater than 30%. In some embodiments, the present invention provides an electrode with a porosity having a lower percentage greater than 35%. In some embodiments, the present invention provides an electrode with a porosity having a lower percentage greater than 40%. In some embodiments, the present invention provides an electrode with a porosity having a lower percentage greater than 45%. In some embodiments, the present invention provides an electrode with a porosity having a lower percentage greater than 50%. In some embodiments, the present invention provides an electrode with a porosity having a lower percentage greater than 55%. In some embodiments, the present invention provides an electrode with a porosity having a lower percentage greater than 60%.

In some embodiments, the present invention provides an electrode with a porosity having a lower percentage of from 0% to 60%. In some embodiments, the present invention provides an electrode with a porosity having a lower percentage of from 0% to 55%. In some embodiments, the present invention provides an electrode with a porosity having a lower percentage of from 0% to 50%. In some embodiments, the present invention provides an electrode with a porosity having a lower percentage of from 0% to 45%. In some embodiments, the present invention provides an electrode with a porosity having a lower percentage of from 0% to 40%. In some embodiments, the present invention provides an electrode with a porosity having a lower percentage of from 0% to 35%. In some embodiments, the present invention provides an electrode with a porosity having a lower percentage of from 0% to 30%. In some embodiments, the present invention provides an electrode with a porosity having a lower percentage of from 0% to 25%. In some embodiments, the present invention provides an electrode with a porosity having a lower percentage of from 0% to 20%. In some embodiments, the present invention provides an electrode with a porosity having a lower percentage of from 0% to 15%. In some embodiments, the present invention provides an electrode with a porosity having a lower percentage of from 0% to 10%. In some embodiments, the present invention provides an electrode with a porosity having a lower percentage of from 0% to 5%. In some embodiments, the present invention provides an electrode with a porosity having a lower percentage of from 0% to 4%. In some embodiments, the present invention provides an electrode with a porosity having a lower percentage of from 0% to 3%. In some embodiments, the present invention provides an electrode with a porosity having a lower percentage of from 0% to 2%. In some embodiments, the present invention provides an electrode with a porosity having a lower percentage of from 0% to 1%.

In some embodiments, the present invention provides an electrode with a porosity having a lower percentage of from 1% to 60%. In some embodiments, the present invention provides an electrode with a porosity having a lower percentage of from 1% to 55%. In some embodiments, the present invention provides an electrode with a porosity having a lower percentage of from 1% to 50%. In some embodiments, the present invention provides an electrode with a porosity having a lower percentage of from 1% to 45%. In some embodiments, the present invention provides an electrode with a porosity having a lower percentage of from 1% to 40%. In some embodiments, the present invention provides an electrode with a porosity having a lower percentage of from 1% to 35%. In some embodiments, the present invention provides an electrode with a porosity having a lower percentage of from 1% to 30%. In some embodiments, the present invention provides an electrode with a porosity having a lower percentage of from 1% to 25%. In some embodiments, the present invention provides an electrode with a porosity having a lower percentage of from 1% to 20%. In some embodiments, the present invention provides an electrode with a porosity having a lower percentage of from 1% to 15%. In some embodiments, the present invention provides an electrode with a porosity having a lower percentage of from 1% to 10%. In some embodiments, the present invention provides an electrode with a porosity having a lower percentage of from 1% to 5%. In some embodiments, the present invention provides an electrode with a porosity having a lower percentage of from 1% to 4%. In some embodiments, the present invention provides an electrode with a porosity having a lower percentage of from 1% to 3%. In some embodiments, the present invention provides an electrode with a porosity having a lower percentage of from 1% to 2%.

In some embodiments, the present invention provides an electrode with a porosity having a lower percentage of from 2% to 60%. In some embodiments, the present invention provides an electrode with a porosity having a lower percentage of from 2% to 55%. In some embodiments, the present invention provides an electrode with a porosity having a lower percentage of from 2% to 50%. In some embodiments, the present invention provides an electrode with a porosity having a lower percentage of from 2% to 45%. In some embodiments, the present invention provides an electrode with a porosity having a lower percentage of from 2% to 40%. In some embodiments, the present invention provides an electrode with a porosity having a lower percentage of from 2% to 35%. In some embodiments, the present invention provides an electrode with a porosity having a lower percentage of from 2% to 30%. In some embodiments, the present invention provides an electrode with a porosity having a lower percentage of from 2% to 25%. In some embodiments, the present invention provides an electrode with a porosity having a lower percentage of from 2% to 20%. In some embodiments, the present invention provides an electrode with a porosity having a lower percentage of from 2% to 15%. In some embodiments, the present invention provides an electrode with a porosity having a lower percentage of from 2% to 10%. In some embodiments, the present invention provides an electrode with a porosity having a lower percentage of from 2% to 5%. In some embodiments, the present invention provides an electrode with a porosity having a lower percentage of from 2% to 4%. In some embodiments, the present invention provides an electrode with a porosity having a lower percentage of from 2% to 3%.

In some embodiments, the present invention provides an electrode with a porosity having a lower percentage of from 3% to 60%. In some embodiments, the present invention provides an electrode with a porosity having a lower percentage of from 3% to 55%. In some embodiments, the present invention provides an electrode with a porosity having a lower percentage of from 3% to 50%. In some embodiments, the present invention provides an electrode with a porosity having a lower percentage of from 3% to 45%. In some embodiments, the present invention provides an electrode with a porosity having a lower percentage of from 3% to 40%. In some embodiments, the present invention provides an electrode with a porosity having a lower percentage of from 3% to 35%. In some embodiments, the present invention provides an electrode with a porosity having a lower percentage of from 3% to 30%. In some embodiments, the present invention provides an electrode with a porosity having a lower percentage of from 3% to 25%. In some embodiments, the present invention provides an electrode with a porosity having a lower percentage of from 3% to 20%. In some embodiments, the present invention provides an electrode with a porosity having a lower percentage of from 3% to 15%. In some embodiments, the present invention provides an electrode with a porosity having a lower percentage of from 3% to 10%. In some embodiments, the present invention provides an electrode with a porosity having a lower percentage of from 3% to 5%. In some embodiments, the present invention provides an electrode with a porosity having a lower percentage of from 3% to 4%.

In some embodiments, the present invention provides an electrode with a porosity having a lower percentage of from 4% to 60%. In some embodiments, the present invention provides an electrode with a porosity having a lower percentage of from 4% to 55%. In some embodiments, the present invention provides an electrode with a porosity having a lower percentage of from 4% to 50%. In some embodiments, the present invention provides an electrode with a porosity having a lower percentage of from 4% to 45%. In some embodiments, the present invention provides an electrode with a porosity having a lower percentage of from 4% to 40%. In some embodiments, the present invention provides an electrode with a porosity having a lower percentage of from 4% to 35%. In some embodiments, the present invention provides an electrode with a porosity having a lower percentage of from 4% to 30%. In some embodiments, the present invention provides an electrode with a porosity having a lower percentage of from 4% to 25%. In some embodiments, the present invention provides an electrode with a porosity having a lower percentage of from 4% to 20%. In some embodiments, the present invention provides an electrode with a porosity having a lower percentage of from 4% to 15%. In some embodiments, the present invention provides an electrode with a porosity having a lower percentage of from 4% to 10%. In some embodiments, the present invention provides an electrode with a porosity having a lower percentage of from 4% to 5%.

In some embodiments, the present invention provides an electrode with a porosity having a lower percentage of from 5% to 60%. In some embodiments, the present invention provides an electrode with a porosity having a lower percentage of from 5% to 55%. In some embodiments, the present invention provides an electrode with a porosity having a lower percentage of from 5% to 50%. In some embodiments, the present invention provides an electrode with a porosity having a lower percentage of from 5% to 45%. In some embodiments, the present invention provides an electrode with a porosity having a lower percentage of from 5% to 40%. In some embodiments, the present invention provides an electrode with a porosity having a lower percentage of from 5% to 35%. In some embodiments, the present invention provides an electrode with a porosity having a lower percentage of from 5% to 30%. In some embodiments, the present invention provides an electrode with a porosity having a lower percentage of from 5% to 25%. In some embodiments, the present invention provides an electrode with a porosity having a lower percentage of from 5% to 20%. In some embodiments, the present invention provides an electrode with a porosity having a lower percentage of from 5% to 15%. In some embodiments, the present invention provides an electrode with a porosity having a lower percentage of from 5% to 10%.

In some embodiments, the present invention provides an electrode with a porosity having a lower percentage of from 10% to 60%. In some embodiments, the present invention provides an electrode with a porosity having a lower percentage of from 10% to 55%. In some embodiments, the present invention provides an electrode with a porosity having a lower percentage of from 10% to 50%. In some embodiments, the present invention provides an electrode with a porosity having a lower percentage of from 10% to 45%. In some embodiments, the present invention provides an electrode with a porosity having a lower percentage of from 10% to 40%. In some embodiments, the present invention provides an electrode with a porosity having a lower percentage of from 10% to 35%. In some embodiments, the present invention provides an electrode with a porosity having a lower percentage of from 10% to 30%. In some embodiments, the present invention provides an electrode with a porosity having a lower percentage of from 10% to 25%. In some embodiments, the present invention provides an electrode with a porosity having a lower percentage of from 10% to 20%. In some embodiments, the present invention provides an electrode with a porosity having a lower percentage of from 10% to 15%.

In some embodiments, the present invention provides an electrode with a porosity having a lower percentage of from 15% to 60%. In some embodiments, the present invention provides an electrode with a porosity having a lower percentage of from 15% to 55%. In some embodiments, the present invention provides an electrode with a porosity having a lower percentage of from 15% to 50%. In some embodiments, the present invention provides an electrode with a porosity having a lower percentage of from 15% to 45%. In some embodiments, the present invention provides an electrode with a porosity having a lower percentage of from 15% to 40%. In some embodiments, the present invention provides an electrode with a porosity having a lower percentage of from 15% to 35%. In some embodiments, the present invention provides an electrode with a porosity having a lower percentage of from 15% to 30%. In some embodiments, the present invention provides an electrode with a porosity having a lower percentage of from 15% to 25%. In some embodiments, the present invention provides an electrode with a porosity having a lower percentage of from 15% to 20%.

In some embodiments, the present invention provides an electrode with a porosity having a lower percentage of from 20% to 60%. In some embodiments, the present invention provides an electrode with a porosity having a lower percentage of from 20% to 55%. In some embodiments, the present invention provides an electrode with a porosity having a lower percentage of from 20% to 50%. In some embodiments, the present invention provides an electrode with a porosity having a lower percentage of from 20% to 45%. In some embodiments, the present invention provides an electrode with a porosity having a lower percentage of from 20% to 40%. In some embodiments, the present invention provides an electrode with a porosity having a lower percentage of from 20% to 35%. In some embodiments, the present invention provides an electrode with a porosity having a lower percentage of from 20% to 30%. In some embodiments, the present invention provides an electrode with a porosity having a lower percentage of from 20% to 25%.

In some embodiments, the present invention provides an electrode with a porosity having a lower percentage of from 25% to 60%. In some embodiments, the present invention provides an electrode with a porosity having a lower percentage of from 25% to 55%. In some embodiments, the present invention provides an electrode with a porosity having a lower percentage of from 25% to 50%. In some embodiments, the present invention provides an electrode with a porosity having a lower percentage of from 25% to 45%. In some embodiments, the present invention provides an electrode with a porosity having a lower percentage of from 25% to 40%. In some embodiments, the present invention provides an electrode with a porosity having a lower percentage of from 25% to 35%. In some embodiments, the present invention provides an electrode with a porosity having a lower percentage of from 25% to 30%.

In some embodiments, the present invention provides an electrode with a porosity having a lower percentage of from 30% to 60%. In some embodiments, the present invention provides an electrode with a porosity having a lower percentage of from 30% to 55%. In some embodiments, the present invention provides an electrode with a porosity having a lower percentage of from 30% to 50%. In some embodiments, the present invention provides an electrode with a porosity having a lower percentage of from 30% to 45%. In some embodiments, the present invention provides an electrode with a porosity having a lower percentage of from 30% to 40%. In some embodiments, the present invention provides an electrode with a porosity having a lower percentage of from 30% to 35%.

In some embodiments, the present invention provides an electrode with a porosity having a lower percentage of from 40% to 60%. In some embodiments, the present invention provides an electrode with a porosity having a lower percentage of from 40% to 55%. In some embodiments, the present invention provides an electrode with a porosity having a lower percentage of from 40% to 50%. In some embodiments, the present invention provides an electrode with a porosity having a lower percentage of from 40% to 45%.

In some embodiments, the present invention provides an electrode with a porosity having a lower percentage of from 45% to 60%. In some embodiments, the present invention provides an electrode with a porosity having a lower percentage of from 45% to 55%. In some embodiments, the present invention provides an electrode with a porosity having a lower percentage of from 45% to 50%. In some embodiments, the present invention provides an electrode with a porosity having a lower percentage of from 50% to 60%. In some embodiments, the present invention provides an electrode with a porosity having a lower percentage of from 50% to 55%. In some embodiments, the present invention provides an electrode with a porosity having a lower percentage of from 55% to 60%. In some embodiments, the present invention provides an electrode with a porosity having a lower percentage of from 20% to 33%.

In some embodiments, the present invention provides an electrode with a porosity having a higher percentage of 30%. In some embodiments, the present invention provides an electrode with a porosity having a higher percentage of 31%. In some embodiments, the present invention provides an electrode with a porosity having a higher percentage of 32%. In some embodiments, the present invention provides an electrode with a porosity having a higher percentage of 33%. In some embodiments, the present invention provides an electrode with a porosity having a higher percentage of 34%. In some embodiments, the present invention provides an electrode with a porosity having a higher percentage of 35%. In some embodiments, the present invention provides an electrode with a porosity having a higher percentage of 36%. In some embodiments, the present invention provides an electrode with a porosity having a higher percentage of 37%. In some embodiments, the present invention provides an electrode with a porosity having a higher percentage of 38%. In some embodiments, the present invention provides an electrode with a porosity having a higher percentage of 39%. In some embodiments, the present invention provides an electrode with a porosity having a higher percentage of 40%. In some embodiments, the present invention provides an electrode with a porosity having a higher percentage of 45%. In some embodiments, the present invention provides an electrode with a porosity having a higher percentage of 50%. In some embodiments, the present invention provides an electrode with a porosity having a higher percentage of 55%. In some embodiments, the present invention provides an electrode with a porosity having a higher percentage of 60%. In some embodiments, the present invention provides an electrode with a porosity having a higher percentage of 65%. In some embodiments, the present invention provides an electrode with a porosity having a higher percentage of 70%. In some embodiments, the present invention provides an electrode with a porosity having a higher percentage of 75%. In some embodiments, the present invention provides an electrode with a porosity having a higher percentage of 80%. In some embodiments, the present invention provides an electrode with a porosity having a higher percentage of 85%. In some embodiments, the present invention provides an electrode with a porosity having a higher percentage of 90%. In some embodiments, the present invention provides an electrode with a porosity having a higher percentage of 95%. In some embodiments, the present invention provides an electrode with a porosity having a higher percentage of 96%. In some embodiments, the present invention provides an electrode with a porosity having a higher percentage of 97%. In some embodiments, the present invention provides an electrode with a porosity having a higher percentage of 98%. In some embodiments, the present invention provides an electrode with a porosity having a higher percentage of 99%.

In some embodiments, the present invention provides an electrode with a porosity having a higher percentage of greater than 30%. In some embodiments, the present invention provides an electrode with a porosity having a higher percentage of greater than 31%. In some embodiments, the present invention provides an electrode with a porosity having a higher percentage of greater than 32%. In some embodiments, the present invention provides an electrode with a porosity having a higher percentage of greater than 33%. In some embodiments, the present invention provides an electrode with a porosity having a higher percentage of greater than 34%. In some embodiments, the present invention provides an electrode with a porosity having a higher percentage of greater than 35%. In some embodiments, the present invention provides an electrode with a porosity having a higher percentage of greater than 36%. In some embodiments, the present invention provides an electrode with a porosity having a higher percentage of greater than 37%. In some embodiments, the present invention provides an electrode with a porosity having a higher percentage of greater than 38%. In some embodiments, the present invention provides an electrode with a porosity having a higher percentage of greater than 39%. In some embodiments, the present invention provides an electrode with a porosity having a higher percentage of greater than 40%. In some embodiments, the present invention provides an electrode with a porosity having a higher percentage of greater than 45%. In some embodiments, the present invention provides an electrode with a porosity having a higher percentage of greater than 50%. In some embodiments, the present invention provides an electrode with a porosity having a higher percentage of greater than 55%. In some embodiments, the present invention provides an electrode with a porosity having a higher percentage of greater than 60%. In some embodiments, the present invention provides an electrode with a porosity having a higher percentage of greater than 65%. In some embodiments, the present invention provides an electrode with a porosity having a higher percentage of greater than 70%. In some embodiments, the present invention provides an electrode with a porosity having a higher percentage of greater than 75%. In some embodiments, the present invention provides an electrode with a porosity having a higher percentage of greater than 80%. In some embodiments, the present invention provides an electrode with a porosity having a higher percentage of greater than 85%. In some embodiments, the present invention provides an electrode with a porosity having a higher percentage of greater than 90%. In some embodiments, the present invention provides an electrode with a porosity having a higher percentage of greater than 95%. In some embodiments, the present invention provides an electrode with a porosity having a higher percentage of greater than 96%. In some embodiments, the present invention provides an electrode with a porosity having a higher percentage of greater than 97%. In some embodiments, the present invention provides an electrode with a porosity having a higher percentage of greater than 98%. In some embodiments, the present invention provides an electrode with a porosity having a higher percentage of greater than 99%.

In some embodiments, the present invention provides an electrode with a porosity having a higher percentage of less than 30%. In some embodiments, the present invention provides an electrode with a porosity having a higher percentage of less than 31%. In some embodiments, the present invention provides an electrode with a porosity having a higher percentage of less than 32%. In some embodiments, the present invention provides an electrode with a porosity having a higher percentage of less than 33%. In some embodiments, the present invention provides an electrode with a porosity having a higher percentage of less than 34%. In some embodiments, the present invention provides an electrode with a porosity having a higher percentage of less than 35%. In some embodiments, the present invention provides an electrode with a porosity having a higher percentage of less than 36%. In some embodiments, the present invention provides an electrode with a porosity having a higher percentage of less than 37%. In some embodiments, the present invention provides an electrode with a porosity having a higher percentage of less than 38%. In some embodiments, the present invention provides an electrode with a porosity having a higher percentage of less than 39%. In some embodiments, the present invention provides an electrode with a porosity having a higher percentage of less than 40%. In some embodiments, the present invention provides an electrode with a porosity having a higher percentage of less than 45%. In some embodiments, the present invention provides an electrode with a porosity having a higher percentage of less than 50%. In some embodiments, the present invention provides an electrode with a porosity having a higher percentage of less than 55%. In some embodiments, the present invention provides an electrode with a porosity having a higher percentage of less than 60%. In some embodiments, the present invention provides an electrode with a porosity having a higher percentage of less than 65%. In some embodiments, the present invention provides an electrode with a porosity having a higher percentage of less than 70%. In some embodiments, the present invention provides an electrode with a porosity having a higher percentage of less than 75%. In some embodiments, the present invention provides an electrode with a porosity having a higher percentage of less than 80%. In some embodiments, the present invention provides an electrode with a porosity having a higher percentage of less than 85%. In some embodiments, the present invention provides an electrode with a porosity having a higher percentage of less than 90%. In some embodiments, the present invention provides an electrode with a porosity having a higher percentage of less than 95%. In some embodiments, the present invention provides an electrode with a porosity having a higher percentage of less than 96%. In some embodiments, the present invention provides an electrode with a porosity having a higher percentage of less than 97%. In some embodiments, the present invention provides an electrode with a porosity having a higher percentage of less than 98%. In some embodiments, the present invention provides an electrode with a porosity having a higher percentage of less than 99%.

In some embodiments, the present invention provides an electrode with a porosity having a higher percentage of from 30% to 99%. In some embodiments, the present invention provides an electrode with a porosity having a higher percentage of from 31% to 99%. In some embodiments, the present invention provides an electrode with a porosity having a higher percentage of from 32% to 99%. In some embodiments, the present invention provides an electrode with a porosity having a higher percentage of from 33% to 99%. In some embodiments, the present invention provides an electrode with a porosity having a higher percentage of from 34% to 99%. In some embodiments, the present invention provides an electrode with a porosity having a higher percentage of from 35% to 99%. In some embodiments, the present invention provides an electrode with a porosity having a higher percentage of from 36% to 99%. In some embodiments, the present invention provides an electrode with a porosity having a higher percentage of from 37% to 99%. In some embodiments, the present invention provides an electrode with a porosity having a higher percentage of from 38% to 99%. In some embodiments, the present invention provides an electrode with a porosity having a higher percentage of from 39% to 99%. In some embodiments, the present invention provides an electrode with a porosity having a higher percentage of from 40% to 99%. In some embodiments, the present invention provides an electrode with a porosity having a higher percentage of from 45% to 99%. In some embodiments, the present invention provides an electrode with a porosity having a higher percentage of from 50% to 99%. In some embodiments, the present invention provides an electrode with a porosity having a higher percentage of from 55% to 99%. In some embodiments, the present invention provides an electrode with a porosity having a higher percentage of from 60% to 99%. In some embodiments, the present invention provides an electrode with a porosity having a higher percentage of from 65% to 99%. In some embodiments, the present invention provides an electrode with a porosity having a higher percentage of from 70% to 99%. In some embodiments, the present invention provides an electrode with a porosity having a higher percentage of from 75% to 99%. In some embodiments, the present invention provides an electrode with a porosity having a higher percentage of from 80% to 99%. In some embodiments, the present invention provides an electrode with a porosity having a higher percentage of from 85% to 99%. In some embodiments, the present invention provides an electrode with a porosity having a higher percentage of from 90% to 99%. In some embodiments, the present invention provides an electrode with a porosity having a higher percentage of from 95% to 99%. In some embodiments, the present invention provides an electrode with a porosity having a higher percentage of from 96% to 99%. In some embodiments, the present invention provides an electrode with a porosity having a higher percentage of from 97% to 99%. In some embodiments, the present invention provides an electrode with a porosity having a higher percentage of from 98% to 99%.

In some embodiments, the present invention provides an electrode with a porosity having a higher percentage of from 30% to 98%. In some embodiments, the present invention provides an electrode with a porosity having a higher percentage of from 31% to 98%. In some embodiments, the present invention provides an electrode with a porosity having a higher percentage of from 32% to 98%. In some embodiments, the present invention provides an electrode with a porosity having a higher percentage of from 33% to 98%. In some embodiments, the present invention provides an electrode with a porosity having a higher percentage of from 34% to 98%. In some embodiments, the present invention provides an electrode with a porosity having a higher percentage of from 35% to 98%. In some embodiments, the present invention provides an electrode with a porosity having a higher percentage of from 36% to 98%. In some embodiments, the present invention provides an electrode with a porosity having a higher percentage of from 37% to 98%. In some embodiments, the present invention provides an electrode with a porosity having a higher percentage of from 38% to 98%. In some embodiments, the present invention provides an electrode with a porosity having a higher percentage of from 39% to 98%. In some embodiments, the present invention provides an electrode with a porosity having a higher percentage of from 40% to 98%. In some embodiments, the present invention provides an electrode with a porosity having a higher percentage of from 45% to 98%. In some embodiments, the present invention provides an electrode with a porosity having a higher percentage of from 50% to 98%. In some embodiments, the present invention provides an electrode with a porosity having a higher percentage of from 55% to 98%. In some embodiments, the present invention provides an electrode with a porosity having a higher percentage of from 60% to 98%. In some embodiments, the present invention provides an electrode with a porosity having a higher percentage of from 65% to 98%. In some embodiments, the present invention provides an electrode with a porosity having a higher percentage of from 70% to 98%. In some embodiments, the present invention provides an electrode with a porosity having a higher percentage of from 75% to 98%. In some embodiments, the present invention provides an electrode with a porosity having a higher percentage of from 80% to 98%. In some embodiments, the present invention provides an electrode with a porosity having a higher percentage of from 85% to 98%. In some embodiments, the present invention provides an electrode with a porosity having a higher percentage of from 90% to 98%. In some embodiments, the present invention provides an electrode with a porosity having a higher percentage of from 95% to 98%. In some embodiments, the present invention provides an electrode with a porosity having a higher percentage of from 96% to 98%. In some embodiments, the present invention provides an electrode with a porosity having a higher percentage of from 97% to 98%.

In some embodiments, the present invention provides an electrode with a porosity having a higher percentage of from 30% to 97%. In some embodiments, the present invention provides an electrode with a porosity having a higher percentage of from 31% to 97%. In some embodiments, the present invention provides an electrode with a porosity having a higher percentage of from 32% to 97%. In some embodiments, the present invention provides an electrode with a porosity having a higher percentage of from 33% to 97%. In some embodiments, the present invention provides an electrode with a porosity having a higher percentage of from 34% to 97%. In some embodiments, the present invention provides an electrode with a porosity having a higher percentage of from 35% to 97%. In some embodiments, the present invention provides an electrode with a porosity having a higher percentage of from 36% to 97%. In some embodiments, the present invention provides an electrode with a porosity having a higher percentage of from 37% to 97%. In some embodiments, the present invention provides an electrode with a porosity having a higher percentage of from 38% to 97%. In some embodiments, the present invention provides an electrode with a porosity having a higher percentage of from 39% to 97%. In some embodiments, the present invention provides an electrode with a porosity having a higher percentage of from 40% to 97%. In some embodiments, the present invention provides an electrode with a porosity having a higher percentage of from 45% to 97%. In some embodiments, the present invention provides an electrode with a porosity having a higher percentage of from 50% to 97%. In some embodiments, the present invention provides an electrode with a porosity having a higher percentage of from 55% to 97%. In some embodiments, the present invention provides an electrode with a porosity having a higher percentage of from 60% to 97%. In some embodiments, the present invention provides an electrode with a porosity having a higher percentage of from 65% to 97%. In some embodiments, the present invention provides an electrode with a porosity having a higher percentage of from 70% to 97%. In some embodiments, the present invention provides an electrode with a porosity having a higher percentage of from 75% to 97%. In some embodiments, the present invention provides an electrode with a porosity having a higher percentage of from 80% to 97%. In some embodiments, the present invention provides an electrode with a porosity having a higher percentage of from 85% to 97%. In some embodiments, the present invention provides an electrode with a porosity having a higher percentage of from 90% to 97%. In some embodiments, the present invention provides an electrode with a porosity having a higher percentage of from 95% to 97%. In some embodiments, the present invention provides an electrode with a porosity having a higher percentage of from 96% to 97%.

In some embodiments, the present invention provides an electrode with a porosity having a higher percentage of from 30% to 96%. In some embodiments, the present invention provides an electrode with a porosity having a higher percentage of from 31% to 96%. In some embodiments, the present invention provides an electrode with a porosity having a higher percentage of from 32% to 96%. In some embodiments, the present invention provides an electrode with a porosity having a higher percentage of from 33% to 96%. In some embodiments, the present invention provides an electrode with a porosity having a higher percentage of from 34% to 96%. In some embodiments, the present invention provides an electrode with a porosity having a higher percentage of from 35% to 96%. In some embodiments, the present invention provides an electrode with a porosity having a higher percentage of from 36% to 96%. In some embodiments, the present invention provides an electrode with a porosity having a higher percentage of from 37% to 96%. In some embodiments, the present invention provides an electrode with a porosity having a higher percentage of from 38% to 96%. In some embodiments, the present invention provides an electrode with a porosity having a higher percentage of from 39% to 96%. In some embodiments, the present invention provides an electrode with a porosity having a higher percentage of from 40% to 96%. In some embodiments, the present invention provides an electrode with a porosity having a higher percentage of from 45% to 96%. In some embodiments, the present invention provides an electrode with a porosity having a higher percentage of from 50% to 96%. In some embodiments, the present invention provides an electrode with a porosity having a higher percentage of from 55% to 96%. In some embodiments, the present invention provides an electrode with a porosity having a higher percentage of from 60% to 96%. In some embodiments, the present invention provides an electrode with a porosity having a higher percentage of from 65% to 96%. In some embodiments, the present invention provides an electrode with a porosity having a higher percentage of from 70% to 96%. In some embodiments, the present invention provides an electrode with a porosity having a higher percentage of from 75% to 96%. In some embodiments, the present invention provides an electrode with a porosity having a higher percentage of from 80% to 96%. In some embodiments, the present invention provides an electrode with a porosity having a higher percentage of from 85% to 96%. In some embodiments, the present invention provides an electrode with a porosity having a higher percentage of from 90% to 96%. In some embodiments, the present invention provides an electrode with a porosity having a higher percentage of from 95% to 96%.

In some embodiments, the present invention provides an electrode with a porosity having a higher percentage of from 30% to 95%. In some embodiments, the present invention provides an electrode with a porosity having a higher percentage of from 31% to 95%. In some embodiments, the present invention provides an electrode with a porosity having a higher percentage of from 32% to 95%. In some embodiments, the present invention provides an electrode with a porosity having a higher percentage of from 33% to 95%. In some embodiments, the present invention provides an electrode with a porosity having a higher percentage of from 34% to 95%. In some embodiments, the present invention provides an electrode with a porosity having a higher percentage of from 35% to 95%. In some embodiments, the present invention provides an electrode with a porosity having a higher percentage of from 36% to 95%. In some embodiments, the present invention provides an electrode with a porosity having a higher percentage of from 37% to 95%. In some embodiments, the present invention provides an electrode with a porosity having a higher percentage of from 38% to 95%. In some embodiments, the present invention provides an electrode with a porosity having a higher percentage of from 39% to 95%. In some embodiments, the present invention provides an electrode with a porosity having a higher percentage of from 40% to 95%. In some embodiments, the present invention provides an electrode with a porosity having a higher percentage of from 45% to 95%. In some embodiments, the present invention provides an electrode with a porosity having a higher percentage of from 50% to 95%. In some embodiments, the present invention provides an electrode with a porosity having a higher percentage of from 55% to 95%. In some embodiments, the present invention provides an electrode with a porosity having a higher percentage of from 60% to 95%. In some embodiments, the present invention provides an electrode with a porosity having a higher percentage of from 65% to 95%. In some embodiments, the present invention provides an electrode with a porosity having a higher percentage of from 70% to 95%. In some embodiments, the present invention provides an electrode with a porosity having a higher percentage of from 75% to 95%. In some embodiments, the present invention provides an electrode with a porosity having a higher percentage of from 80% to 95%. In some embodiments, the present invention provides an electrode with a porosity having a higher percentage of from 85% to 95%. In some embodiments, the present invention provides an electrode with a porosity having a higher percentage of from 90% to 95%.

In some embodiments, the present invention provides an electrode with a porosity having a higher percentage of from 30% to 90%. In some embodiments, the present invention provides an electrode with a porosity having a higher percentage of from 31% to 90%. In some embodiments, the present invention provides an electrode with a porosity having a higher percentage of from 32% to 90%. In some embodiments, the present invention provides an electrode with a porosity having a higher percentage of from 33% to 90%. In some embodiments, the present invention provides an electrode with a porosity having a higher percentage of from 34% to 90%. In some embodiments, the present invention provides an electrode with a porosity having a higher percentage of from 35% to 90%. In some embodiments, the present invention provides an electrode with a porosity having a higher percentage of from 36% to 90%. In some embodiments, the present invention provides an electrode with a porosity having a higher percentage of from 37% to 90%. In some embodiments, the present invention provides an electrode with a porosity having a higher percentage of from 38% to 90%. In some embodiments, the present invention provides an electrode with a porosity having a higher percentage of from 39% to 90%. In some embodiments, the present invention provides an electrode with a porosity having a higher percentage of from 40% to 90%. In some embodiments, the present invention provides an electrode with a porosity having a higher percentage of from 45% to 90%. In some embodiments, the present invention provides an electrode with a porosity having a higher percentage of from 50% to 90%. In some embodiments, the present invention provides an electrode with a porosity having a higher percentage of from 55% to 90%. In some embodiments, the present invention provides an electrode with a porosity having a higher percentage of from 60% to 90%. In some embodiments, the present invention provides an electrode with a porosity having a higher percentage of from 65% to 90%. In some embodiments, the present invention provides an electrode with a porosity having a higher percentage of from 70% to 90%. In some embodiments, the present invention provides an electrode with a porosity having a higher percentage of from 75% to 90%. In some embodiments, the present invention provides an electrode with a porosity having a higher percentage of from 80% to 90%. In some embodiments, the present invention provides an electrode with a porosity having a higher percentage of from 85% to 90%.

In some embodiments, the present invention provides an electrode with a porosity having a higher percentage of from 30% to 85%. In some embodiments, the present invention provides an electrode with a porosity having a higher percentage of from 31% to 85%. In some embodiments, the present invention provides an electrode with a porosity having a higher percentage of from 32% to 85%. In some embodiments, the present invention provides an electrode with a porosity having a higher percentage of from 33% to 85%. In some embodiments, the present invention provides an electrode with a porosity having a higher percentage of from 34% to 85%. In some embodiments, the present invention provides an electrode with a porosity having a higher percentage of from 35% to 85%. In some embodiments, the present invention provides an electrode with a porosity having a higher percentage of from 36% to 85%. In some embodiments, the present invention provides an electrode with a porosity having a higher percentage of from 37% to 85%. In some embodiments, the present invention provides an electrode with a porosity having a higher percentage of from 38% to 85%. In some embodiments, the present invention provides an electrode with a porosity having a higher percentage of from 39% to 85%. In some embodiments, the present invention provides an electrode with a porosity having a higher percentage of from 40% to 85%. In some embodiments, the present invention provides an electrode with a porosity having a higher percentage of from 45% to 85%. In some embodiments, the present invention provides an electrode with a porosity having a higher percentage of from 50% to 85%. In some embodiments, the present invention provides an electrode with a porosity having a higher percentage of from 55% to 85%. In some embodiments, the present invention provides an electrode with a porosity having a higher percentage of from 60% to 85%. In some embodiments, the present invention provides an electrode with a porosity having a higher percentage of from 65% to 85%. In some embodiments, the present invention provides an electrode with a porosity having a higher percentage of from 70% to 85%. In some embodiments, the present invention provides an electrode with a porosity having a higher percentage of from 75% to 85%. In some embodiments, the present invention provides an electrode with a porosity having a higher percentage of from 80% to 85%.

In some embodiments, the present invention provides an electrode with a porosity having a higher percentage of from 30% to 80%. In some embodiments, the present invention provides an electrode with a porosity having a higher percentage of from 31% to 80%. In some embodiments, the present invention provides an electrode with a porosity having a higher percentage of from 32% to 80%. In some embodiments, the present invention provides an electrode with a porosity having a higher percentage of from 33% to 80%. In some embodiments, the present invention provides an electrode with a porosity having a higher percentage of from 34% to 80%. In some embodiments, the present invention provides an electrode with a porosity having a higher percentage of from 35% to 80%. In some embodiments, the present invention provides an electrode with a porosity having a higher percentage of from 36% to 80%. In some embodiments, the present invention provides an electrode with a porosity having a higher percentage of from 37% to 80%. In some embodiments, the present invention provides an electrode with a porosity having a higher percentage of from 38% to 80%. In some embodiments, the present invention provides an electrode with a porosity having a higher percentage of from 39% to 80%. In some embodiments, the present invention provides an electrode with a porosity having a higher percentage of from 40% to 80%. In some embodiments, the present invention provides an electrode with a porosity having a higher percentage of from 45% to 80%. In some embodiments, the present invention provides an electrode with a porosity having a higher percentage of from 50% to 80%. In some embodiments, the present invention provides an electrode with a porosity having a higher percentage of from 55% to 80%. In some embodiments, the present invention provides an electrode with a porosity having a higher percentage of from 60% to 80%. In some embodiments, the present invention provides an electrode with a porosity having a higher percentage of from 65% to 80%. In some embodiments, the present invention provides an electrode with a porosity having a higher percentage of from 70% to 80%. In some embodiments, the present invention provides an electrode with a porosity having a higher percentage of from 75% to 80%.

In some embodiments, the present invention provides an electrode with a porosity having a higher percentage of from 30% to 75%. In some embodiments, the present invention provides an electrode with a porosity having a higher percentage of from 31% to 75%. In some embodiments, the present invention provides an electrode with a porosity having a higher percentage of from 32% to 75%. In some embodiments, the present invention provides an electrode with a porosity having a higher percentage of from 33% to 75%. In some embodiments, the present invention provides an electrode with a porosity having a higher percentage of from 34% to 75%. In some embodiments, the present invention provides an electrode with a porosity having a higher percentage of from 35% to 75%. In some embodiments, the present invention provides an electrode with a porosity having a higher percentage of from 36% to 75%. In some embodiments, the present invention provides an electrode with a porosity having a higher percentage of from 37% to 75%. In some embodiments, the present invention provides an electrode with a porosity having a higher percentage of from 38% to 75%. In some embodiments, the present invention provides an electrode with a porosity having a higher percentage of from 39% to 75%. In some embodiments, the present invention provides an electrode with a porosity having a higher percentage of from 40% to 75%. In some embodiments, the present invention provides an electrode with a porosity having a higher percentage of from 45% to 75%. In some embodiments, the present invention provides an electrode with a porosity having a higher percentage of from 50% to 75%. In some embodiments, the present invention provides an electrode with a porosity having a higher percentage of from 55% to 75%. In some embodiments, the present invention provides an electrode with a porosity having a higher percentage of from 60% to 75%. In some embodiments, the present invention provides an electrode with a porosity having a higher percentage of from 65% to 75%. In some embodiments, the present invention provides an electrode with a porosity having a higher percentage of from 70% to 75%.

In some embodiments, the present invention provides an electrode with a porosity having a higher percentage of from 30% to 70%. In some embodiments, the present invention provides an electrode with a porosity having a higher percentage of from 31% to 70%. In some embodiments, the present invention provides an electrode with a porosity having a higher percentage of from 32% to 70%. In some embodiments, the present invention provides an electrode with a porosity having a higher percentage of from 33% to 70%. In some embodiments, the present invention provides an electrode with a porosity having a higher percentage of from 34% to 70%. In some embodiments, the present invention provides an electrode with a porosity having a higher percentage of from 35% to 70%. In some embodiments, the present invention provides an electrode with a porosity having a higher percentage of from 36% to 70%. In some embodiments, the present invention provides an electrode with a porosity having a higher percentage of from 37% to 70%. In some embodiments, the present invention provides an electrode with a porosity having a higher percentage of from 38% to 70%. In some embodiments, the present invention provides an electrode with a porosity having a higher percentage of from 39% to 70%. In some embodiments, the present invention provides an electrode with a porosity having a higher percentage of from 40% to 70%. In some embodiments, the present invention provides an electrode with a porosity having a higher percentage of from 45% to 70%. In some embodiments, the present invention provides an electrode with a porosity having a higher percentage of from 50% to 70%. In some embodiments, the present invention provides an electrode with a porosity having a higher percentage of from 55% to 70%. In some embodiments, the present invention provides an electrode with a porosity having a higher percentage of from 60% to 70%. In some embodiments, the present invention provides an electrode with a porosity having a higher percentage of from 65% to 70%.

In some embodiments, the present invention provides an electrode with a porosity having a higher percentage of from 30% to 65%. In some embodiments, the present invention provides an electrode with a porosity having a higher percentage of from 31% to 65%. In some embodiments, the present invention provides an electrode with a porosity having a higher percentage of from 32% to 65%. In some embodiments, the present invention provides an electrode with a porosity having a higher percentage of from 33% to 65%. In some embodiments, the present invention provides an electrode with a porosity having a higher percentage of from 34% to 65%. In some embodiments, the present invention provides an electrode with a porosity having a higher percentage of from 35% to 65%. In some embodiments, the present invention provides an electrode with a porosity having a higher percentage of from 36% to 65%. In some embodiments, the present invention provides an electrode with a porosity having a higher percentage of from 37% to 65%. In some embodiments, the present invention provides an electrode with a porosity having a higher percentage of from 38% to 65%. In some embodiments, the present invention provides an electrode with a porosity having a higher percentage of from 39% to 65%. In some embodiments, the present invention provides an electrode with a porosity having a higher percentage of from 40% to 65%. In some embodiments, the present invention provides an electrode with a porosity having a higher percentage of from 45% to 65%. In some embodiments, the present invention provides an electrode with a porosity having a higher percentage of from 50% to 65%. In some embodiments, the present invention provides an electrode with a porosity having a higher percentage of from 55% to 65%. In some embodiments, the present invention provides an electrode with a porosity having a higher percentage of from 60% to 65%.

In some embodiments, the present invention provides an electrode with a porosity having a higher percentage of from 30% to 60%. In some embodiments, the present invention provides an electrode with a porosity having a higher percentage of from 31% to 60%. In some embodiments, the present invention provides an electrode with a porosity having a higher percentage of from 32% to 60%. In some embodiments, the present invention provides an electrode with a porosity having a higher percentage of from 33% to 60%. In some embodiments, the present invention provides an electrode with a porosity having a higher percentage of from 34% to 60%. In some embodiments, the present invention provides an electrode with a porosity having a higher percentage of from 35% to 60%. In some embodiments, the present invention provides an electrode with a porosity having a higher percentage of from 36% to 60%. In some embodiments, the present invention provides an electrode with a porosity having a higher percentage of from 37% to 60%. In some embodiments, the present invention provides an electrode with a porosity having a higher percentage of from 38% to 60%. In some embodiments, the present invention provides an electrode with a porosity having a higher percentage of from 39% to 60%. In some embodiments, the present invention provides an electrode with a porosity having a higher percentage of from 40% to 60%. In some embodiments, the present invention provides an electrode with a porosity having a higher percentage of from 45% to 60%. In some embodiments, the present invention provides an electrode with a porosity having a higher percentage of from 50% to 60%. In some embodiments, the present invention provides an electrode with a porosity having a higher percentage of from 55% to 60%.

In some embodiments, the present invention provides an electrode with a porosity having a higher percentage of from 30% to 55%. In some embodiments, the present invention provides an electrode with a porosity having a higher percentage of from 31% to 55%. In some embodiments, the present invention provides an electrode with a porosity having a higher percentage of from 32% to 55%. In some embodiments, the present invention provides an electrode with a porosity having a higher percentage of from 33% to 55%. In some embodiments, the present invention provides an electrode with a porosity having a higher percentage of from 34% to 55%. In some embodiments, the present invention provides an electrode with a porosity having a higher percentage of from 35% to 55%. In some embodiments, the present invention provides an electrode with a porosity having a higher percentage of from 36% to 55%. In some embodiments, the present invention provides an electrode with a porosity having a higher percentage of from 37% to 55%. In some embodiments, the present invention provides an electrode with a porosity having a higher percentage of from 38% to 55%. In some embodiments, the present invention provides an electrode with a porosity having a higher percentage of from 39% to 55%. In some embodiments, the present invention provides an electrode with a porosity having a higher percentage of from 40% to 55%. In some embodiments, the present invention provides an electrode with a porosity having a higher percentage of from 45% to 55%. In some embodiments, the present invention provides an electrode with a porosity having a higher percentage of from 50% to 55%.

In some embodiments, the present invention provides an electrode with a porosity having a higher percentage of from 30% to 50%. In some embodiments, the present invention provides an electrode with a porosity having a higher percentage of from 31% to 50%. In some embodiments, the present invention provides an electrode with a porosity having a higher percentage of from 32% to 50%. In some embodiments, the present invention provides an electrode with a porosity having a higher percentage of from 33% to 50%. In some embodiments, the present invention provides an electrode with a porosity having a higher percentage of from 34% to 50%. In some embodiments, the present invention provides an electrode with a porosity having a higher percentage of from 35% to 50%. In some embodiments, the present invention provides an electrode with a porosity having a higher percentage of from 36% to 50%. In some embodiments, the present invention provides an electrode with a porosity having a higher percentage of from 37% to 50%. In some embodiments, the present invention provides an electrode with a porosity having a higher percentage of from 38% to 50%. In some embodiments, the present invention provides an electrode with a porosity having a higher percentage of from 39% to 50%. In some embodiments, the present invention provides an electrode with a porosity having a higher percentage of from 40% to 50%. In some embodiments, the present invention provides an electrode with a porosity having a higher percentage of from 45% to 50%.

In some embodiments, the present invention provides an electrode with a porosity having a higher percentage of from 30% to 45%. In some embodiments, the present invention provides an electrode with a porosity having a higher percentage of from 31% to 45%. In some embodiments, the present invention provides an electrode with a porosity having a higher percentage of from 32% to 45%. In some embodiments, the present invention provides an electrode with a porosity having a higher percentage of from 33% to 45%. In some embodiments, the present invention provides an electrode with a porosity having a higher percentage of from 34% to 45%. In some embodiments, the present invention provides an electrode with a porosity having a higher percentage of from 35% to 45%. In some embodiments, the present invention provides an electrode with a porosity having a higher percentage of from 36% to 45%. In some embodiments, the present invention provides an electrode with a porosity having a higher percentage of from 37% to 45%. In some embodiments, the present invention provides an electrode with a porosity having a higher percentage of from 38% to 45%. In some embodiments, the present invention provides an electrode with a porosity having a higher percentage of from 39% to 45%. In some embodiments, the present invention provides an electrode with a porosity having a higher percentage of from 40% to 45%.

In some embodiments, the present invention provides an electrode with a porosity having a higher percentage of from 30% to 40%. In some embodiments, the present invention provides an electrode with a porosity having a higher percentage of from 31% to 40%. In some embodiments, the present invention provides an electrode with a porosity having a higher percentage of from 32% to 40%. In some embodiments, the present invention provides an electrode with a porosity having a higher percentage of from 33% to 40%. In some embodiments, the present invention provides an electrode with a porosity having a higher percentage of from 34% to 40%. In some embodiments, the present invention provides an electrode with a porosity having a higher percentage of from 35% to 40%. In some embodiments, the present invention provides an electrode with a porosity having a higher percentage of from 36% to 40%. In some embodiments, the present invention provides an electrode with a porosity having a higher percentage of from 37% to 40%. In some embodiments, the present invention provides an electrode with a porosity having a higher percentage of from 38% to 40%. In some embodiments, the present invention provides an electrode with a porosity having a higher percentage of from 39% to 40%.

In some embodiments, the present invention provides an electrode with a porosity having a higher percentage of from 30% to 39%. In some embodiments, the present invention provides an electrode with a porosity having a higher percentage of from 31% to 39%. In some embodiments, the present invention provides an electrode with a porosity having a higher percentage of from 32% to 39%. In some embodiments, the present invention provides an electrode with a porosity having a higher percentage of from 33% to 39%. In some embodiments, the present invention provides an electrode with a porosity having a higher percentage of from 34% to 39%. In some embodiments, the present invention provides an electrode with a porosity having a higher percentage of from 35% to 39%. In some embodiments, the present invention provides an electrode with a porosity having a higher percentage of from 36% to 39%. In some embodiments, the present invention provides an electrode with a porosity having a higher percentage of from 37% to 39%. In some embodiments, the present invention provides an electrode with a porosity having a higher percentage of from 38% to 39%.

In some embodiments, the present invention provides an electrode with a porosity having a higher percentage of from 30% to 38%. In some embodiments, the present invention provides an electrode with a porosity having a higher percentage of from 31% to 38%. In some embodiments, the present invention provides an electrode with a porosity having a higher percentage of from 32% to 38%. In some embodiments, the present invention provides an electrode with a porosity having a higher percentage of from 33% to 38%. In some embodiments, the present invention provides an electrode with a porosity having a higher percentage of from 34% to 38%. In some embodiments, the present invention provides an electrode with a porosity having a higher percentage of from 35% to 38%. In some embodiments, the present invention provides an electrode with a porosity having a higher percentage of from 36% to 38%. In some embodiments, the present invention provides an electrode with a porosity having a higher percentage of from 37% to 38%.

In some embodiments, the present invention provides an electrode with a porosity having a higher percentage of from 30% to 37%. In some embodiments, the present invention provides an electrode with a porosity having a higher percentage of from 31% to 37%. In some embodiments, the present invention provides an electrode with a porosity having a higher percentage of from 32% to 37%. In some embodiments, the present invention provides an electrode with a porosity having a higher percentage of from 33% to 37%. In some embodiments, the present invention provides an electrode with a porosity having a higher percentage of from 34% to 37%. In some embodiments, the present invention provides an electrode with a porosity having a higher percentage of from 35% to 37%. In some embodiments, the present invention provides an electrode with a porosity having a higher percentage of from 36% to 37%.

In some embodiments, the present invention provides an electrode with a porosity having a higher percentage of from 30% to 36%. In some embodiments, the present invention provides an electrode with a porosity having a higher percentage of from 31% to 36%. In some embodiments, the present invention provides an electrode with a porosity having a higher percentage of from 32% to 36%. In some embodiments, the present invention provides an electrode with a porosity having a higher percentage of from 33% to 36%. In some embodiments, the present invention provides an electrode with a porosity having a higher percentage of from 34% to 36%. In some embodiments, the present invention provides an electrode with a porosity having a higher percentage of from 35% to 36%.

In some embodiments, the present invention provides an electrode with a porosity having a higher percentage of from 30% to 35%. In some embodiments, the present invention provides an electrode with a porosity having a higher percentage of from 31% to 35%. In some embodiments, the present invention provides an electrode with a porosity having a higher percentage of from 32% to 35%. In some embodiments, the present invention provides an electrode with a porosity having a higher percentage of from 33% to 35%. In some embodiments, the present invention provides an electrode with a porosity having a higher percentage of from 34% to 35%.

In some embodiments, the present invention provides an electrode with a porosity having a higher percentage of from 30% to 34%. In some embodiments, the present invention provides an electrode with a porosity having a higher percentage of from 31% to 34%. In some embodiments, the present invention provides an electrode with a porosity having a higher percentage of from 32% to 34%. In some embodiments, the present invention provides an electrode with a porosity having a higher percentage of from 33% to 34%.

In some embodiments, the present invention provides an electrode with a porosity having a higher percentage of from 30% to 33%. In some embodiments, the present invention provides an electrode with a porosity having a higher percentage of from 31% to 33%. In some embodiments, the present invention provides an electrode with a porosity having a higher percentage of from 32% to 33%. In some embodiments, the present invention provides an electrode with a porosity having a higher percentage of from 30% to 32%. In some embodiments, the present invention provides an electrode with a porosity having a higher percentage of from 31% to 32%. In some embodiments, the present invention provides an electrode with a porosity having a higher percentage of from 30% to 31%.

In some embodiments, the porosity is formed by radiation.

In some embodiments, the porosity is formed by laser radiation.

In some embodiments, the radiation is rastered across the electrode.

In some embodiments, the radiation is rastered across a surface of the electrode.

In some embodiments, the laser radiation is rastered across the electrode.

In some embodiments, the laser radiation is rastered across a surface of the electrode.

In some embodiments, the electrode with a porosity is a positive electrode of a battery. In some embodiments, the electrode with a porosity is a negative electrode of a battery. In some embodiments, a battery includes both a positive electrode with a porosity and a negative electrode with a porosity.

In some embodiments, a battery includes a positive electrode and a negative electrode.

In some embodiments, the positive electrode and the negative electrode of the battery are stacked vertically relative to each other.

In some embodiments, a positive electrode with a porosity and/or a negative electrode with a porosity are laminated when staked vertically.

In some embodiments, an electrolyte is interposed between the positive electrode and the negative electrode.

In some embodiments, the positive electrode includes a porosity. In some embodiments, the negative electrode includes a porosity. In some embodiments, the positive electrode includes a porosity, and the negative electrode includes a porosity.

In some embodiments, the electrolyte resides within the porosity of the positive electrode. In some embodiments, the electrolyte resides within the porosity of the negative electrode. In some embodiments, the electrolyte resides within the porosity of the positive electrode and within the porosity of the negative electrode.

In some embodiments, the porosity of the negative electrode varies laterally. In some embodiments, the porosity of the positive electrode varies laterally. In some embodiments, the porosity of the positive electrode and of the negative electrode varies laterally.

In some embodiments, the positive electrode with a porosity, and/or the negative electrode with a porosity, are within an electrochemical battery.

In some embodiments, the positive electrode with a porosity, and/or the negative electrode with a porosity, are within a lithium battery.

In some embodiments, a volume of a porosity is efficiently minimized to conserve volume while still maintaining a high rate of function.

In some embodiments, the electrode with a porosity may be a thick electrode. In some embodiments, the electrode with a porosity may be for an ultra-high energy density battery. In some embodiments, the electrode with a porosity may be for a battery including a low conductivity electrolyte. In some embodiments, the electrode with a porosity may be for an ultra-high energy density battery including a low conductivity electrolyte. In some embodiments, either or both of the positive electrode and/or the negative electrode may include a porosity.

In some embodiments, a porosity of an electrode may be increased adjacent an electronically insulating layer (e.g., a separator), and decreased adjacent a collector. In some embodiments, a porosity of an electrode increased adjacent an electronically insulating layer (e.g., a separator) and decreased adjacent a collector may reduce tortuosity (electrolyte diffusivity gradient).

In some embodiments, the present invention provides a method of manufacturing an electrode with a porosity.

In some embodiments, the present invention provides a method for creating porosity in an ultra-high energy density battery.

In some embodiments, the porosity in the electrode may be generated by laser which varies the thickness, volume, and location of pores.

In some embodiments, the invention may alter a battery structure by adding porosity variations either vertically and/or laterally to a positive electrode and/or a negative electrode.

In some embodiments, the porosity can range from a lower percentage apart from a current collector, to a higher percentage either laterally near the current collector or adjacent to the electrolyte/electronically insulating layer. In some embodiments, the porosity is arranged in a vertical gradient structure where the different porosities are near each other within the laminating layers of the electrode.

In some embodiments, a thickness of the positive electrode, and/or of the negative electrode, may be altered. In some embodiments, the positive electrode and/or negative electrode may have a thickness from 150 to 300 microns. In some embodiments, the positive electrode and/or negative electrode may have a thickness from 20 to 150 microns.

In some embodiments, the present invention provides a method of making thick electrodes by laminating electrodes of various porosity vertical to the separator plane.

In some embodiments, the present invention provides lateral porosity distributions and gradients in the electrodes parallel to the separator plane.

In some embodiments, a porosity is formed by a laser.

In some embodiments, a porosity is formed by a rastering laser.

In some embodiments, the present invention provides an electrode with a combination of designed porosity distributions in two directions, where one direction is perpendicular to the other direction.

In some embodiments, the present invention provides gradient electrodes perpendicular to the plane of the electronically insulating layer (e.g., a separator) for electrodes greater than 150 microns in thickness.

In some embodiments, the present invention reduces tortuosity of a porosity of the electrode. In some embodiments, reducing tortuosity increases energy density and rate capability, without changing an overall quantity of porosity in the electrode.

In some embodiments, the electrode with a porosity may be used in an electric vehicle battery. In some embodiments, the electrode with a porosity may be used in an electronic device battery. In some embodiments, the electrode with a porosity may be used in an improved performance lithium-ion battery. In some embodiments, the electrode with a porosity may be used in another type of battery. In some embodiments, the electrode with a porosity may be used place of a diffusion electrode in a fuel cell. In some embodiments, in some embodiments of the invention, the porosity may be formed in an electronic component in another electronic device. In some embodiments, the porosity may be formed in a capacitor.

In some embodiments, the present invention provides a battery, comprising: a housing; an electrolyte disposed in the housing; and a first electrode, wherein a porosity of the first electrode varies across a surface of the first electrode.

In some embodiments, the porosity of the first electrode varies in a gradient.

In some embodiments, the first electrode comprise a positive electrode.

In some embodiments, the first electrode comprises a negative electrode.

In some embodiments, the first electrode comprises a positive electrode, and the battery further comprises: a second electrode, wherein the second electrode comprises a negative electrode, and wherein a porosity of the second electrode varies across a surface of the second electrode.

In some embodiments, the porosity of the second electrode varies in a gradient.

In some embodiments, the first electrode has a thickness of from 150 to 300 microns.

In some embodiments, the first electrode has a thickness of from 20 to 150 microns.

In some embodiments, the present invention provides a battery structure comprising: a positive electrode; and a negative electrode, wherein the positive electrode and the negative electrode are stacked vertically with an electrolyte interposed between the two electrode; wherein at least one of the positive electrode and negative electrode contains a porosity in which electrolyte resides; and wherein the porosity of either or both electrodes vary laterally across a surface of the electrode.

In some embodiments, the porosity varies continuously in a gradient.

In some embodiments, the porosity varies non-continuously.

In some embodiments, a minimum porosity is from 0% to 45%.

In some embodiments, the minimum porosity is from 10% to 35%.

In some embodiments, the minimum porosity is from 20% to 33%.

In some embodiments, a maximum porosity is from 36% to 90%.

In some embodiments, the maximum porosity is from 40% to 70%.

In some embodiments, the maximum porosity is from 40% to 60%.

In some embodiments, the porosity is formed through the application of laser radiation.

In some embodiments, the laser radiation is rastered across the electrode surface.

In some embodiments, the battery comprises: current collector tabs; and current collectors; wherein a maximum porosity is formed laterally closest to the current collector tabs, and the porosity decreases systematically away from the current collectors.

In some embodiments, the electrode has a thickness of from 150 to 300 microns in thickness.

In some embodiments, the electrode has a thickness of from 20 to 150 microns in thickness.

In some embodiments, the electrode has a vertical porosity gradient.

In some embodiments, the battery comprises an electrolyte/separator layer, wherein the maximum porosity is adjacent the electrolyte/separator layer.

In some embodiments, the electrode comprises layers of electrode materials having different porosities, wherein the layers are laminated together.

In some embodiments, the present invention provides a method of making an electrode with a porosity gradient between a separator and a current collector.

In some embodiments, multiple electrode layers of predesigned porosity are laminated together to provide an interface free electrode with a porosity gradient.

In some embodiments, a maximum porosity is at an interface of the electrode and the separator layer.

In some embodiments, the electrode is comprised of a negative or positive active electrode material, a conductive additive such as carbon, a binder such as PVdF-HFP, and a plasticizer to tune the porosity percentage.

In some embodiments, the multiple electrode layers of varying porosity are laminated by temperature and pressure to provide the electrode with the porosity gradient.

In some embodiments, the plasticizer is extracted.

In some embodiments, the electrode is laminated to at least one of the current collector and the electronically insulating layer (e.g., a separator).

### Overview

According to a geometrical definition, tortuosity is the ratio between the shortest mass transport between two points and the straight-line distance between the points. However, this definition may not account for constrictions and bottlenecks in the pore structure. A more accurate definition of tortuosity utilizes the effective and intrinsic diffusivity, seen in the equation below:

$${D}_{eff} = \frac{ε}{τ} D$$

where ε is the total porosity of the sample, τ is the tortuosity, and D_{eff} and D are the effective and intrinsic diffusivity, respectively. Effective diffusivity refers to the diffusivity of the electrolyte when it is filled within a porous structure, while intrinsic diffusivity is the diffusivity of the pure electrolyte filling 100% of the volume. Tortuosity is normalized for the percentage of porosity. Therefore, tortuosity can be used to evaluate and compare a pore network's effectiveness to transport ions at any level of porosity. By lowering the tortuosity of the pore network in electrodes, greater fast rate capacities can be achieved, which offset the diminishing returns of increasing electrode thickness without removing active material.

One way to reduce tortuosity in thick electrodes is to alter the distribution of porosity in the electrode. By fabricating a gradient in porosity, with low porosity near the current collector (where a low Li+ flux exists) and high porosity near the electronically insulating layer (e.g., a separator) (where a high Li+ flux exists), tortuosity of the overall pore network decreases and fast rate capacities are theoretically improved without increasing the total porosity of the electrode. High porosity towards the electronically insulating layer (e.g., a separator) enhances percolation of Li ions through the electrode, reducing the Li ion concentration gradient across the electrode. With low porosity towards the current collector, active material is not lost from the fast rate improvement and can still be accessed for low rate capacity. Previously reported modelling of gradient porosity electrodes has concluded that electrode porosity must gradually decrease from the electronically insulating layer (e.g., a separator) side to the current collector for high performance batteries. However, there have been few experimental validations of this approach and none for thick electrodes. Bonded gradient porosity electrodes of LiNi_{0.8}CO_{0.15}Al_{0.05}O₂ (NCA) and Li₄Ti₅O₁₂ have demonstrated promising experimental results. However, both the NCA and Li₄Ti₅O₁₂ gradient electrodes were not very highly loaded and had lengthy fabrications, which could cause difficulty for manufacturing. The gradient NCA electrode was a dual layered electrode with a loading of 28 mg/cm² and was fabricated with numerous steps including casting the electrode slurry with a doctor-blade, drying the cast for 6 hours, electrospinning a layer of electrode on top of the casted electrode, and pressing the dual electrode with a rolling machine. The gradient Li₄Ti₅O₁₂ electrode had a loading of 20 mg/cm² and required at least 27 hours of drying in a vacuum oven to fabricate a tri-layer gradient electrode.

This approach will be through the scalable fabrication process of plastic electrodes using a modified method developed by Bellcore, where a plasticizer is used to finely tune to the desired porosity. Subsequently, electrodes can be bonded by laminations to create a multi-layered bonded Li-ion battery. The opportunity to easily bond several electrodes together makes plastic electrodes ideal for fabrication of gradient porosity electrodes. By casting several electrodes of various porosities, laminating them in sequential porosity order, and extracting the plasticizer, gradient porosity electrodes could, in theory, be easily fabricated. Additionally, with the ability to laminate several layers of electrodes together, gradient electrodes with more than two different types of porosity are achievable, unlike previous works where only dual porosity electrodes were created. Plastic electrodes also create the opportunity for bondable batteries, where the electrodes are bonded to the electronically insulating layer (e.g., a separator). Bondable batteries are advantageous for reducing dendritic growth and in applications such as flexible electronics.

### Experimental Methods

a. Electrode Fabrication

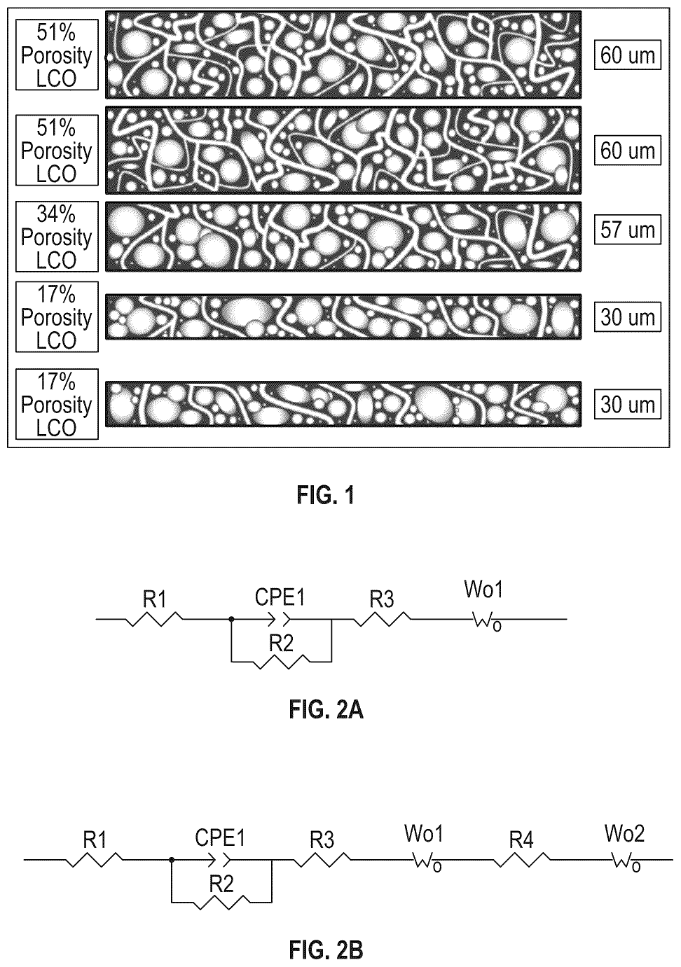

In accordance with some embodiments of the invention, bonded, monolithic electrodes containing a predetermined porosity gradient were created through the implementation of plastic electrode fabrication processes. Five (5) layers of electrodes with various pre-determined porosities, as visualized in FIG. 1, which is a schematic representing porosity and thickness of layers of a laminated gradient electrode in accordance with some embodiments of the invention, were laminated together with heat and pressure to form the bonded electrode with the desired porosity gradient. Each layer of the gradient electrode was fabricated individually first by tape casting on mylar. A slurry in acetone (Sigma Aldrich, ≥99.9% purity) of PVDF-HFP(poly (vinylidene fluoride)-co-hexafluoropropylene, Kynar 2801, Elf Atochem), DBP (dibutyl phthalate, Sigma Aldrich, 99% purity), carbon (Super P, MMM and KS6, Timcal), and LiCoO₂ (LCO) (Seimi) was created by utilizing a Flaktek Speedmixer. PVDF-HFP, DBP, and carbon were added sequentially to acetone and mixed at 1600 min⁻¹ for 10 minutes after each individual component was added. Then, LCO was added to the slurry and mixed at 1600 min⁻¹ for 20 minutes. Once the slurry was well dispersed, it was doctor blade tape casted onto mylar. To alter the percentage of porosity in the electrode, the amount of DBP was adjusted while maintaining the same casting protocol and proportions of all other components relative to each other. The 17% nominal porosity electrode had a formulation of 84.63% LCO, 4.67% carbon, 5.98% PVDF-HFP, and 4.72% DBP. The 34% nominal porosity electrode was fabricated with 79.05% LCO, 4.36% carbon, 5.58% PVDF-HFP, and 11.01% DBP. The 51% nominal porosity electrode had a further increase of the plasticizer with a formulation of 71.06% LCO, 3.92% carbon, 5.02% PVDF-HFP, and 20.00% DBP. After extraction, all electrodes had 88.83% LCO, 4.9% carbon, and 6.27% PVDF-HFP, showing that the ratio between the components remained the same.

Due to the variation in DBP plasticizer quantities, each electrode was densified by a different method to obtain its target porosity. The advantage of this technology is that the porosity is maintained by the incompressible DBP plasticizer as opposed to the challenges of accurate calendaring and extremely high pressures utilized in routine Li-ion battery manufacturing, which may lead to porosity inhomogeneities. 51% porosity electrodes were densified with a laminator at 120 degrees C. and 20 psi. 130 degrees C. and 35 psi were utilized to densify 34% porosity electrodes. For 17% porosity electrodes, a jeweler's mill was used for adequate densification. Once each layer of electrode was individually densified, the 5 layers of electrodes were laminated together in sequential order of porosity with a laminator at 130 degrees C. and 30 psi to create an interface-free bonded electrode. This 5-layer gradient electrode was extracted with diethyl ether (Sigma Aldrich, ≥99.7% purity) for three 10-minute intervals, 30 minutes total, to remove the DBP from the electrode. The laminated electrode monolith showed no visual separation of the layers and excellent adhesion was achieved. To determine if orientation of the gradient porosity had impact on transport, both orientations of the gradient porosity were tested in tortuosity and rate capability. Electrodes with high porosity (51% porosity side) near the electronically insulating layer (e.g., a separator) and low porosity (17% porosity side) near the current collector will be referred to as gradient electrodes, while electrodes with low porosity (17% porosity side) near the electronically insulating layer (e.g., a separator) and high porosity (51% porosity side) near the current collector will be referred to as reverse gradient electrodes. To compare to the gradient electrode, a 4-layer 34% porosity electrode was created by laminating together four densified 34% porosity electrodes at 130 degrees C. and 35 psi and extracting with the same method as the similar average porosity gradient electrode.

b. Physical Characteristics

To visualize differences between low and high porosity electrodes, each electrode was cut with a Jeol IB-09010CP Cross Section Polisher at 7.9 Argon gas and 5 kV for 3.5 hours. Immediately after, a secondary low voltage cut at 11.7 Argon gas and 3 kV for 2 hours was completed to polish the cut electrode. The electrode cross sections were viewed under a Keyence VHX-7000 digital microscope with the VHX-E500 high-resolution high-magnification objective lens at various magnifications.

Secondary electron images of the electrode cross sections were recorded using the Zeiss Orion Plus helium ion microscope at an acceleration voltage of 30 kV. The ion-induced electron emission mechanism provides surface morphological detail, similar to a scanning electron microscope, but with improved depth of field using an incident ion beam with spatial resolution down to ˜0.5 nm. The electrodes required no additional conductive coating. Using charge compensation (low-energy electron gun), the accumulated He+ ions become neutralized resulting in direct visualization of sample morphology. The typical helium beam had a 1.0 pA current and the chamber pressure was 3×10⁻⁷ Torr.

For characterization of the porosity differences between electrodes, Brunauer-Emmett-Teller (BET) surface area and pore distribution analysis was conducted with a Micromeritics ASAP 2020 Surface Area and Porosity Analyzer. The electrode's mass and volume were measured before degassing in the BET. Samples were degassed at 70 degrees C. for at least 20 hours at a ramp rate of 10 degrees C./min. Once degassing was complete, the electrode was analyzed with BET. 82 points were taken for the analysis with various relative pressures (P/Pₒ).

To obtain the measured porosity of the electrode, He pycnometry was conducted with a Micromeritics AccuPyc II 1340 Gas Pycnometer. The measured porosity was calculated by comparing the helium pycnometer density to the apparent density of the electrode with the equation below:

$$\% Total Measured Porosity = ( 1 - \frac{Apparent Density}{He Pycno Density} ) * 100$$

The apparent density was calculated by dividing the mass of the sample by its volume. The measured porosities for the 17%, 34%, and 51% nominal porosity electrodes were 16%, 34%, and 48%, respectively, as displayed in Table 1. Electrodes will be referred to by these measured porosities. The measured average porosity of the gradient porosity electrode was 36%. All gradient electrodes will refer to this 36% measured porosity.

TABLE 1
Table displaying the measured porosity for 17%, 34%, 51%
nominal porosity electrodes and the gradient electrode.

| Electrode | Measured Porosity (%) |
|---|---|
| 17% Porosity | 16.44 |
| 34% Porosity | 33.75 |
| 51% Porosity | 48.20 |
| Gradient | 35.98 |

### Electrochemical Characterization

To characterize electrode tortuosity, electrodes were cored from the larger electrode into 1.11 cm diameter discs. These cored electrodes were dried overnight at 120 degrees C. and then placed into an argon-filled glovebox for electrochemical cell assembly. Symmetrical stainless steel Swagelok cells were made with two electrodes with the same mass and thickness. The electrodes were separated by a glass fiber separator soaked with a blocking electrolyte of 10 mM tetrabutylammonium hexafluorophosphate (TBAPF6) in EC:DMC 1:1. Immediately after the cells were fabricated, electrochemical impedance spectroscopy (EIS) was performed from 0.1 to 10⁶ Hz with a 10 mV amplitude in a dry room. The EIS spectrums were fitted on Zview to obtain an ionic resistance (Rᵢₒₙ) value from the open circuit Warburg. The circuit model used to fit these spectrums is shown in FIG. 2A, which is a circuit model used to fit the EIS spectrums of symmetric electrode cells with completely linear 45° lines, in accordance with some embodiments of the invention.

Resistor 1 (R1) represents the ionic transport in the electrolyte, the constant phase element 1 (CPE1) and resistor 2 (R2) in parallel represent the semicircle produced from the contact resistance of the current collector to the electrode, and resistor 3 (R3) and open circuit Warburg element 1 (Wo1) model the diffusion through the electrode. Wo1 fits the 45° line in the EIS Z″ vs. Z′ Nyquist plot which represents the transport of the ions through only the pores of the electrode since the cells were made with a blocking electrolyte. Blocking electrolytes prevent ion intercalation into the electrode material. The Warburg element resistance (Wo-R) was extracted from the Wo1 element and used as the Rion for tortuosity calculations. For spectrums where the 45° line was curved or containing multiple slope changes, the circuit model in FIG. 2B, and a circuit model used to fit the EIS spectrums with variation in 45° lines, was used instead. This model uses a second Warburg element (Wo2) to accommodate for the variation in the 45° line in the EIS Z″ vs. Z′ Nyquist plot, which was present in electrodes with layers of varying tortuosity, such as the gradient porosity electrodes. Wo-R1 and Wo-R2 were extracted from the Warburg elements and added together to obtain the Rion value. These Rion values were used to calculate tortuosity with the equation below:

$$τ = \frac{{R}_{ion} A κε}{2 d}$$

where τ is tortuosity, Rᵢₒₙ is the ionic resistance obtained from EIS, A is the area of the electrode, K is the conductivity of the electrolyte, ε is the porosity of the electrode, and d is the thickness of electrode.

For rate testing, 1.11 cm diameter electrode disks were used. Coin cells were fabricated with the electrode vs. Li metal (Li half cells), glass fiber separator, and 1M LiPF₆ EMC:EC 70:30 electrolyte. The cells were electrochemically characterized using a Biologic VMP with the protocol shown in Table 2. This protocol includes both full discharges at various rates and discharge signature curves to effectively evaluate a wide spectrum of rates in one discharge.

TABLE 2
Protocol utilized for the electrochemical characterization
of the electrodes in Li half cells. CC refers to constant
current and CV refers to constant voltage

| | Step | Action | Type | Applied | | Cutoff | |
|---|---|---|---|---|---|---|---|
| Complete | 1 | Charge | CC | C/10 | | 4.2 | V |
| Charge/Discharge | 2 | Charge | CV | 4.2 | V | C/20 | |
| | 3 | Discharge | CC | C/10 | | 2.7 | V |
| | | Loop Once to Step 1 | | | | | |
| | 4 | Charge | CC | C/10 | | 4.2 | V |
| | 5 | Charge | CV | 4.2 | V | C/20 | |
| | 6 | Discharge | CC | 1 | C | 2.7 | V |
| | 7 | Charge | CC | C/10 | | 4.2 | V |
| | 8 | Charge | CV | 4.2 | V | C/20 | |
| | 9 | Discharge | CC | 2 | C | 2.7 | V |
| | 10 | Charge | CC | C/10 | | 4.2 | V |
| | 11 | Charge | CV | 4.2 | V | C/20 | |
| Signature | 12 | Discharge | CC | 100 | C | 2.7 | V |
| Discharge | 13 | Rest | — | — | | 15 | min |
| Curve | 14 | Discharge | CC | 50 | C | 2.7 | V |
| | 15 | Rest | — | — | | 15 | min |
| | 16 | Discharge | CC | 20 | C | 2.7 | V |
| | 17 | Rest | — | — | | 15 | min |
| | 18 | Discharge | CC | 10 | C | 2.7 | V |
| | 19 | Rest | — | — | | 15 | min |
| | 20 | Discharge | CC | 5 | C | 2.7 | V |
| | 21 | Rest | — | — | | 15 | min |
| | 22 | Discharge | CC | 2 | C | 2.7 | V |
| | 23 | Rest | — | — | | 15 | min |
| | 24 | Discharge | CC | 1 | C | 2.7 | V |

| | | | | | | |
|---|---|---|---|---|---|---|
| | 25 | Rest | — | — | 15 | min |
| | 26 | Discharge | CC | C/2 | 2.7 | V |
| | 27 | Rest | — | — | 15 | min |
| | 28 | Discharge | CC | C/5 | 2.7 | V |
| | 29 | Rest | — | — | 15 | min |
| | 30 | Discharge | CC | C/10 | 2.7 | V |
| | 31 | Rest | — | — | 15 | min |
| | 32 | Discharge | CC | C/20 | 2.7 | V |
| | 33 | Rest | — | — | 15 | min |
| | 34 | Discharge | CC | C/50 | 2.7 | V |
| | 35 | Rest | — | — | 15 | min |
| Complete | 36 | Discharge | CC | C/100 | 2.7 | V |
| C/D | 37 | Charge | CC | C/10 | 4.2 | V |

| | | | | | |
|---|---|---|---|---|---|
| 38 | Charge | CV | 4.2 | V | C/20 |

| | | | | | |
|---|---|---|---|---|---|
| 39 | Discharge | CC | C/5 | 2.7 | V |

Loop 10x to Step 1

### Results

### 1. Homogeneous Porosity Electrodes

a. Physical Characterization

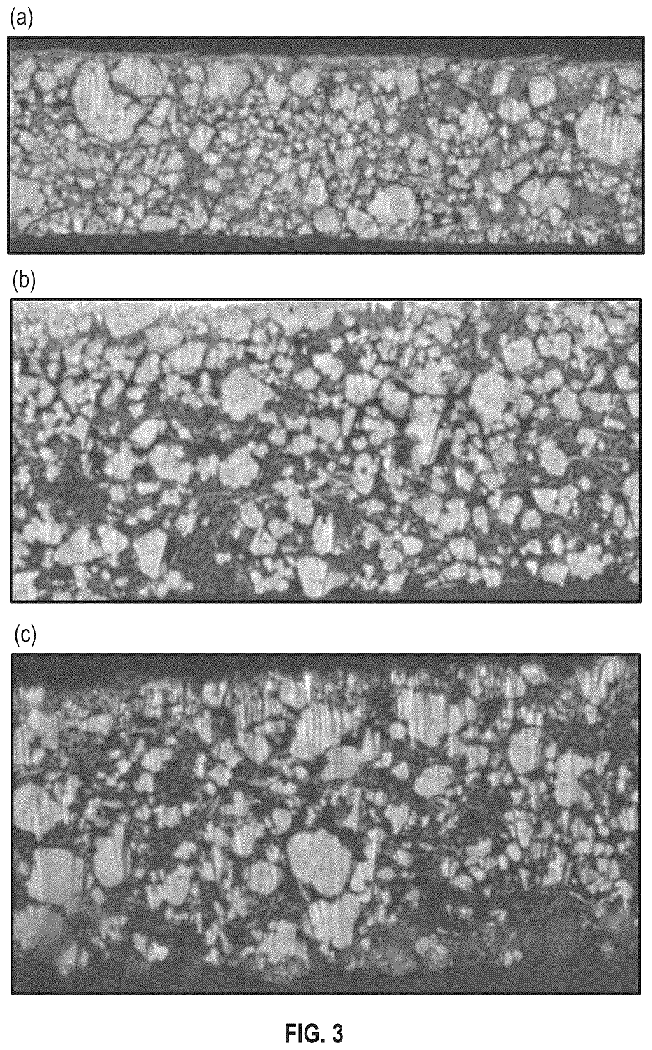

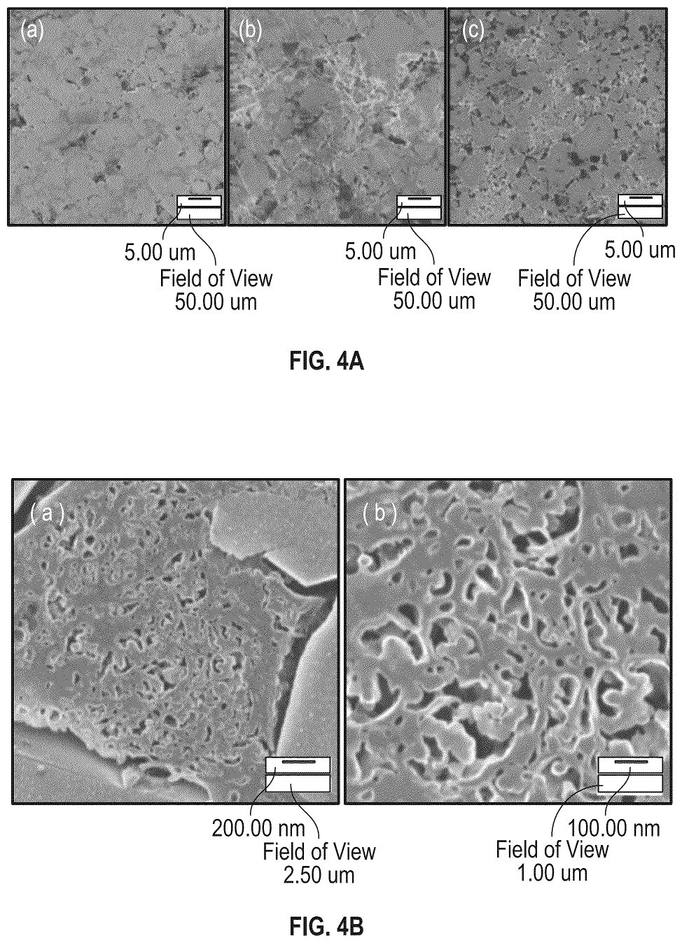

With comparable thicknesses and a homogeneous distribution of porosity, the 16%, 34%, and 48% electrodes only differed in their percentage of porosity, and to a certain extent their homogeneously distributed pore size distributions. Differences in their porosities are clearly observable in their cross sections taken with a digital optical microscope seen in FIG. 3, which show cross sections of 16% (a), 34% (b), and 48% (c) porosity LiCoO₂ (LCO) electrodes taken with digital optical microscope, in accordance with some embodiments of the invention. 16% porosity has densely packed LCO particles, while 48% porosity clearly has significantly more area between LCO particles. This difference in distance between LCO particles represents the increase in porosity from the 16% porosity to the 48% porosity electrode. To further visualize the difference in porosity between electrodes, FIG. 4A display cross sectioned images obtained through He ion microscopy for 16%, 34%, and 48% porosity electrodes, respectively, in accordance with some embodiments of the invention. With a common scalebar of 5 μm, significant systematic contrasts in the amount of porosity are visually apparent, especially when comparing 16% to 48%. The 16% porosity electrode has densely packed LCO particles and minimal porosity that is approximately 0.5-2 μm in size, as shown in FIG. 4A. In contrast, the 48% porosity electrode has widely dispersed LCO particles and significantly greater porosity within the range of 0.5-4 μm in size. Therefore, fabrication of electrodes with contrasting porosities was achieved, and the microscopy results were consistent with the porosity calculations of Table 1. The carbon black itself contains a significant content of microporosity in the 10-100 nm range. This is clearly seen in FIG. 4B, which shows a cross section of a carbon network of 16% porosity LCO electrode, imaged with a He ion microscope at 2.5 μm field of view and 200nm scalebar (a) and 1 μm field of view and 100 nm scalebar (b), in accordance with some embodiments of the invention.

This porosity is greatly different than the macroporosity seen in FIG. 4A, and further evaluated with BET.

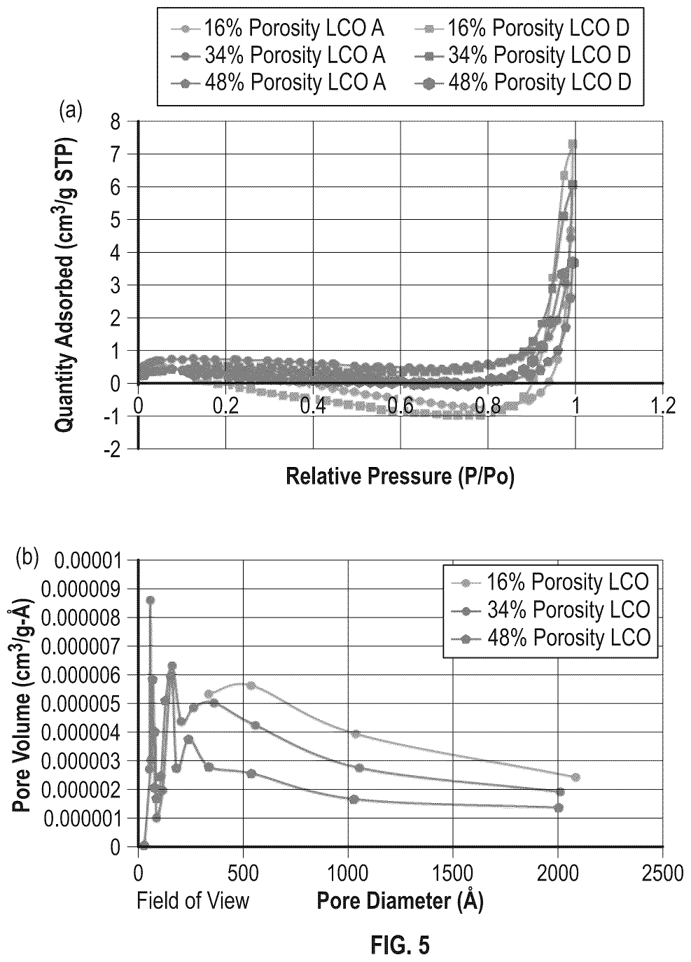

BET porosity was analyzed for each electrode to quantify differences in porosity size distributions. FIG. 5 displays the isotherms and BET pore size distributions of these electrodes. 16% porosity had the tallest isotherm, followed by 48% porosity and then 34% porosity, in accordance with some embodiments of the invention. Specifically, FIG. 5 is a graph showing BET results of single layer 16%, 34%, and 48% porosity electrodes. In the graph isotherms (a) have “A” and “D” labels to represent adsorption and desorption curves, respectively. Pore Volume vs. Pore Diameter (b) displays the distribution of pore sizes in the electrode. The 16% porosity LCO electrode is represented in blue, 34% porosity LCO electrode is represented in green, and 48% porosity LCO electrode is represented in dark orange.

As seen in Table 3, all three electrodes had a small proportion of their total porosity accountable within the BET porosity range which extends to a maximum of approximately 200 nm. 16% porosity electrodes had the most BET porosity with 3.75% of the 16% porosity electrode comprising of these small pores with the reminder of the total porosity being accounted for by 12.68% macroporosity (>200 nm). With a total BET porosity of 1.84%, the 48% porosity electrode had the next greatest percentage of BET pores. This electrode had >200 nm macroporosity of 46.36% and a total porosity of 48.20%. 34% had a similar percentage of BET porosity with 1.44%, and had a macroporosity of 32.31% resulting in a total porosity of 33.75%.

TABLE 3
Table displaying the type of porosity and tortuosity
of 17%, 34%, and 51% nominal porosity electrodes.

| | % Total | | % BET | |
|---|---|---|---|---|
| Electrode | Porosity | % Macroporosity | Porosity | Tortuosity |
| 17% Porosity | 16.44 | 12.68 | 3.75 | 2.33 |
| 34% Porosity | 33.75 | 32.31 | 1.44 | 3.86 |
| 51% Porosity | 48.20 | 46.36 | 1.84 | 3.54 |

b. Electrochemical Characterization

Tortuosity was characterized for each electrode. 34% porosity and 48% porosity had similar average tortuosities of 3.86 and 3.54 respectively, as seen in Table 3. However, 16% porosity had a significantly lower average tortuosity of only 2.33.Tortuosity normalizes for porosity and thickness, so changing the porosity of the electrode should not impact the tortuosity, as demonstrated by the 34% porosity and 48% porosity electrodes. The improved tortuosity of the 16% electrodes was attributed to the greater amount of mesoporosity <200 nm found in the 16% porosity electrodes compared to that of the 34% and 48% electrodes. This is consistent with what has recently been identified as the optimal pore size for minimizing tortuosity of plastic separators.

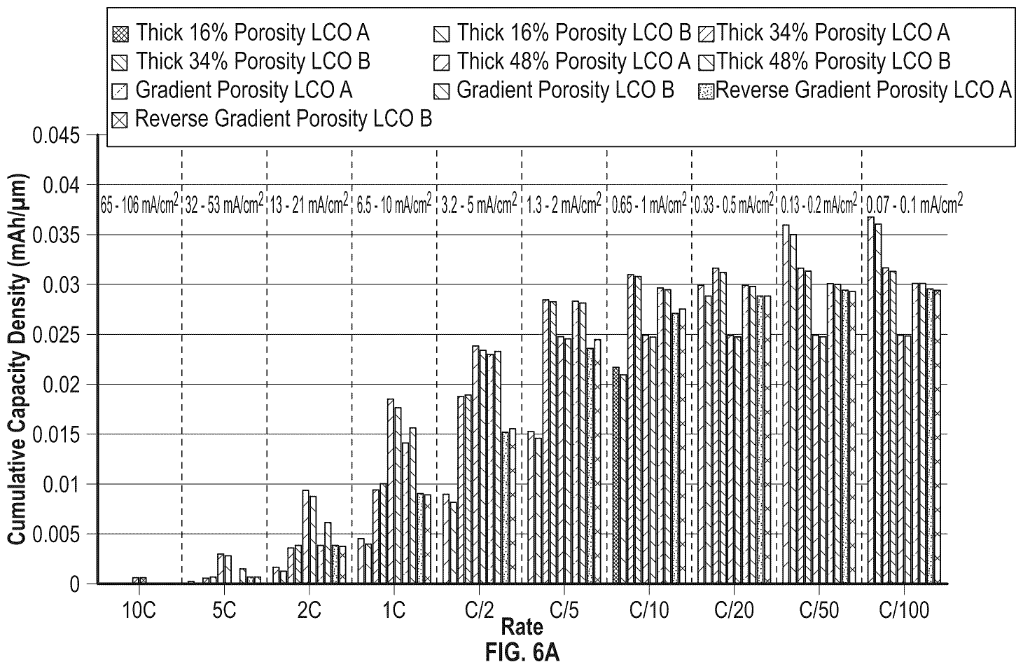

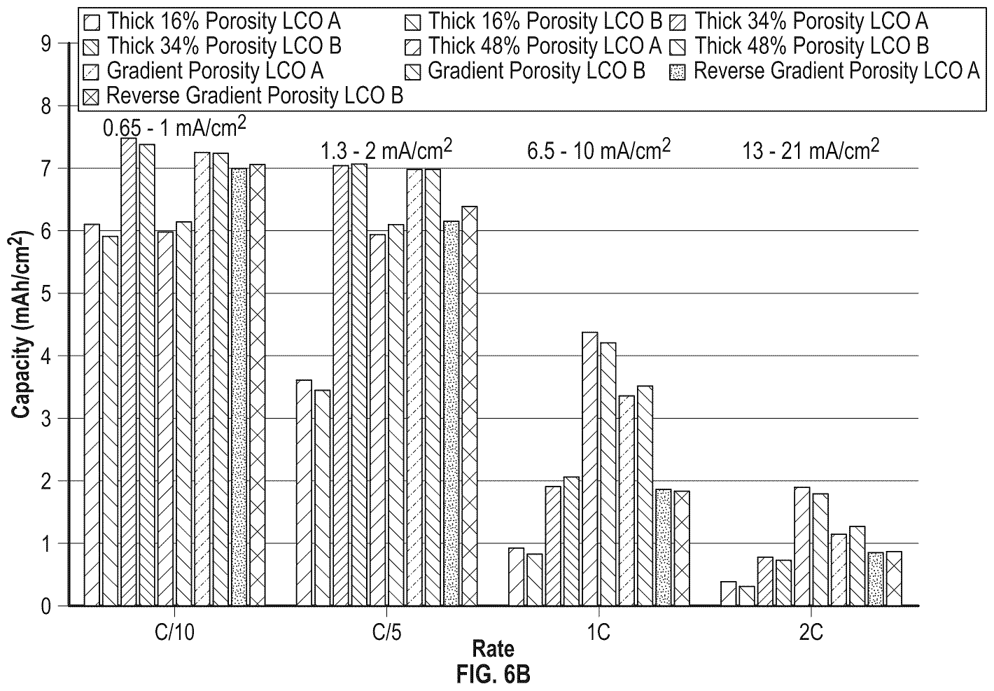

To compare the rate capabilities of these electrodes of contrasting porosity, signature discharge curves were generated. For direct comparison of these homogeneous porosity electrodes with much thicker gradient electrodes, several layers of the thin homogeneous electrodes were laminated together to create ˜230 μm thick homogeneous porosity electrodes. FIG. 6A is a bar graph of Cumulative Capacity Density vs. Rate for signature discharge curves of all electrodes of ˜230 μm thickness, in accordance with some embodiments of the invention. Rates in terms of mA/cm² can be seen in red text. Two cells of each electrode were tested for consistency. Dark and light green represent thick 16% porosity LCO electrodes, dark and light blue represent thick 34% porosity LCO electrodes, dark and light purple represent thick 48% porosity LCO electrodes, orange and yellow represent gradient porosity LCO electrodes, and black and bright purple represent reverse gradient porosity LCO electrodes. Significant differences in the homogeneous electrode rate capabilities are prevalent in FIG. 6A, which displays the cumulative energy density in mAh/μm (representing capacity density) of the signature curves for all electrodes with approximately 230 μm thickness. FIG. 6B shows a bar graph of areal capacity (mAh/cm²) vs. rate for full discharges of all ˜230 μm thick electrodes, in accordance with some embodiments of the invention. Two cells of each electrode were tested for consistency. Dark and light green represent thick 16% porosity LCO electrodes, dark and light blue represent thick 34% porosity LCO electrodes, dark and light purple represent thick 48% porosity LCO electrodes, orange and yellow represent gradient porosity LCO electrodes, and black and bright purple represent reverse gradient porosity LCO electrodes. FIG. 6B presents the electrode rate capacities in mAh/cm². From 10 C to C/2, 48% porosity had the greatest capacity density of the thick homogeneous electrodes. At 1 C, 48% porosity had an average cumulative capacity density of 0.0181 mAh/μm, which was 87% and 331% greater than the 0.0097 mAh/μm and 0.0042 mAh/μm capacity density measured for the 34% and 16% porosity electrodes, respectively.

Although increasing porosity improved the high rate capacity density, the low rate capacity density reduced with increased porosity. From a medium rate of C/5 to C/20, 34% porosity had the greatest cumulative capacity density of the thick homogeneous electrodes. More specifically, once C/5 was reached, 34% porosity surpassed 48% porosity with 0.0284 mAh/μm versus 0.0247 mAh/μm, respectively. 48% porosity had approximately reached its maximum cumulative capacity density by C/2, with minimal increases after C/2. Due to its sluggish kinetics caused by its minimal porosity, 16% porosity only had an average capacity density of 0.0149 mAh/μm at C/5, which was 52% less than 34% porosity. However, both 34% and 16% porosity had not reached their maximum cumulative capacity densities at C/2 because of their higher loadings. By C/10, 34% porosity had approximately reached its maximum cumulative capacity density of 0.0309 mAh/μm, with minimal increases past C/10. At the very slow rate of C/50, 16% porosity surpassed both 34% and 48% porosity with an average cumulative capacity density of 0.0355 mAh/μm. At this rate, 34% and 48% porosity had average cumulative capacity densities of 0.0315 mAh/μm and 0.0249 mAh/μm, which was approximately 11% and 30% less than the 16% porosity electrode, respectively. At the slowest rate of C/100,16% porosity electrodes had an average cumulative capacity density of 0.0364 mAh/μm, which was 15% greater than 34% porosity's 0.0315 mAh/μm and 46% greater than 48% porosity's 0.0249 mAh/μm. Less porosity allows for more active material in the electrode and higher ultimate capacity densities. At low rates, the capacity from densely packed active material is available. Yet at high rates, densely packed active material becomes inaccessible due to poor ionic pathways.

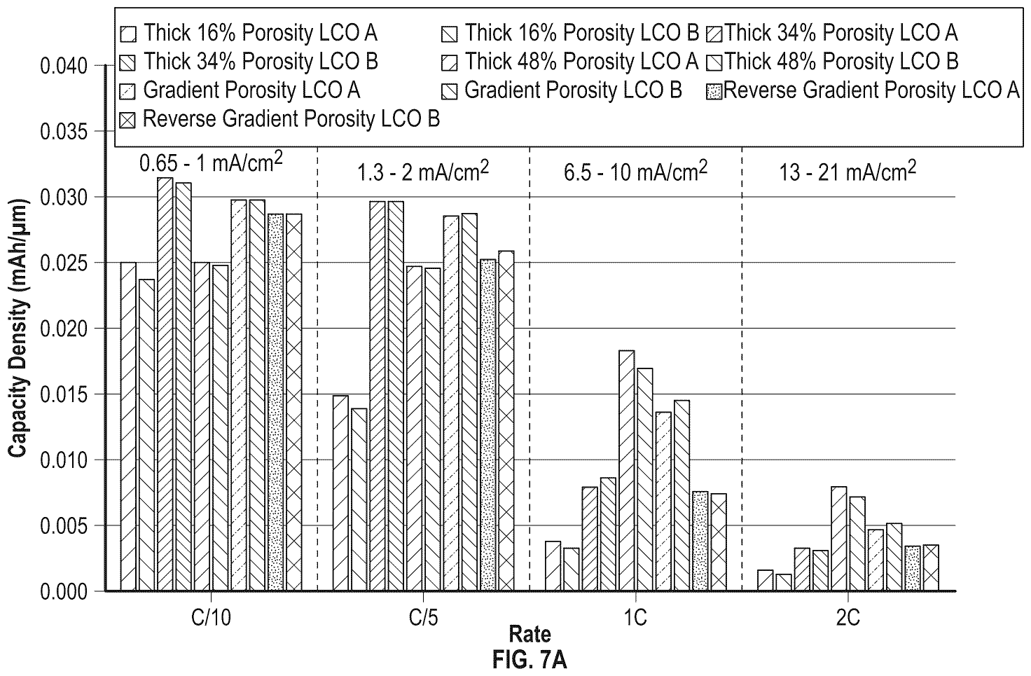

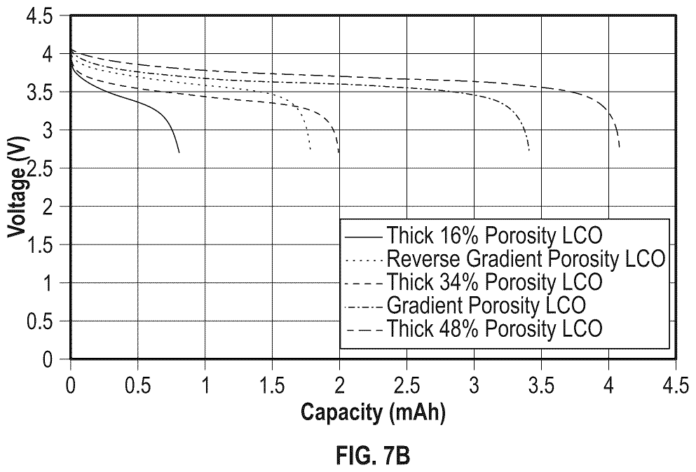

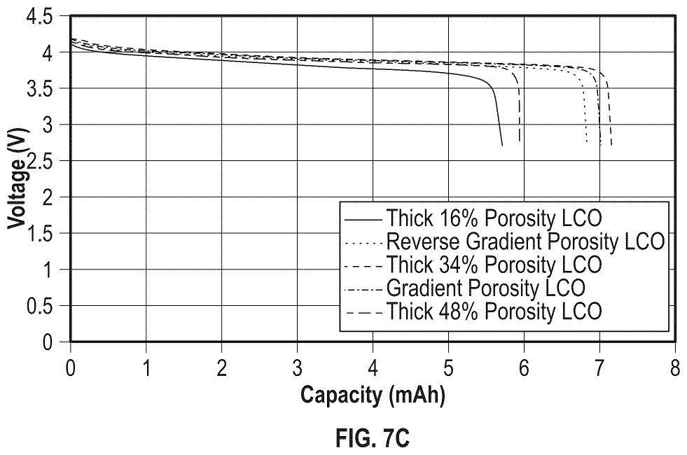

Similar trends in capacity density for high and low rates were also seen in the full discharges and their respective voltage profiles. FIG. 7A is a bar graph of Capacity Density vs. Rate for full discharges at various rates for electrodes of ˜230 μm thickness, in accordance with some embodiments of the invention. Rates in terms of mA/cm² can be seen in red text. Two cells of each electrode were tested for consistency. Dark and light green represent thick 16% porosity LCO electrodes, dark and light blue represent thick 34% porosity LCO electrodes, dark and light purple represent thick 48% porosity LCO electrodes, orange and yellow represent gradient porosity LCO electrodes, and black and bright purple represent reverse gradient porosity LCO electrodes.

FIG. 7A displays the full discharge capacity density at various rates for all ˜230 μm electrodes, while FIG. 7B plots the voltage profiles for these electrodes at 1 C. FIG. 7B is a graph of voltage profiles at 1 C full discharge for electrodes of ˜230 μm thickness, in accordance with some embodiments of the invention. The black line represents thick 16% porosity LCO electrode, red represents reverse gradient porosity LCO electrode, yellow represents thick 34% porosity LCO electrode, green represents gradient porosity LCO electrode, and blue represents thick 48% porosity LCO electrode. At 1 C, 48% porosity electrodes had the greatest average capacity density of 0.0176 mAh/μm. This large capacity density is reflected in 48% porosity's long and flat voltage profile with minimal diffusional attenuation and had the greatest final capacity of all thick electrodes. Considering only the homogeneous porosity electrodes, 34% porosity had the next highest average capacity density of 0.0083 mAh/μm. 16% porosity had the lowest average capacity density of only 0.0036 mAh/μm, which is 80% less than the 48% porosity electrode. The voltage profile of 16% porosity also greatly differed from 48% porosity at 1 C. 16% porosity had a steep and short voltage profile consistent with diffusional limitations, and the lowest final capacity of all the thick electrodes. Minimal ionic pathways in the 16% porosity electrode prevented Li ions from intercalating into the electrode at the fast rate of 1 C, thus, reducing its final capacity compared to its high porosity counterparts.

At a slower full discharge rate of C/10, 34% porosity had the greatest average capacity density with 0.0312 mAh/μm. 48% porosity had the next highest average capacity density of the homogeneous electrodes with 0.0248 mAh/μm. 16% porosity had a slightly lower average capacity density than 48% porosity, with 0.0244 mAh/μm. Although C/10 is a slower rate than 1 C, C/10 was still not slow enough for all the capacity of the 16% porosity electrode to be obtained, especially at these exceptionally high thicknesses greater than 200 μm. Thus, 16% porosity still has the lowest capacity density of the homogeneous electrodes even at C/10. Based on the previous signature curve results in FIG. 6A, the 16% porosity electrodes' capacity density will significantly exceed all others at lower rates approaching C/50. However, C/10 was a slow enough rate for 34% porosity's capacity density to surpass 48% porosity. FIG. 7C shows a graph of voltage profiles at C/10 full discharge for all electrodes of ˜230 μm thickness, in accordance with some embodiments of the invention. Black line represents thick 16% porosity LCO electrode, red represents reverse gradient porosity LCO electrode, yellow represents thick 34% porosity LCO electrode, green represents gradient porosity LCO electrode, and blue represents thick 48% porosity LCO electrode. Full C/10 discharge voltage profiles for all thick electrodes are shown in FIG. 7C. For the homogeneous electrodes, 34% porosity had the highest capacity, followed by 48% porosity, and then 16% porosity. 16% porosity had a lower voltage profile than 34% and 48% porosity's voltage profiles, resulting from the expected diffusional limitations. Hence, homogeneous porosity electrodes limit battery researchers into choosing between high porosity electrodes with lower capacity densities for fast rates, or low porosity electrodes with higher capacity densities that are only suitable for low rates.

### 2. Heterogeneous Gradient Electrodes

a. Physical Characterization

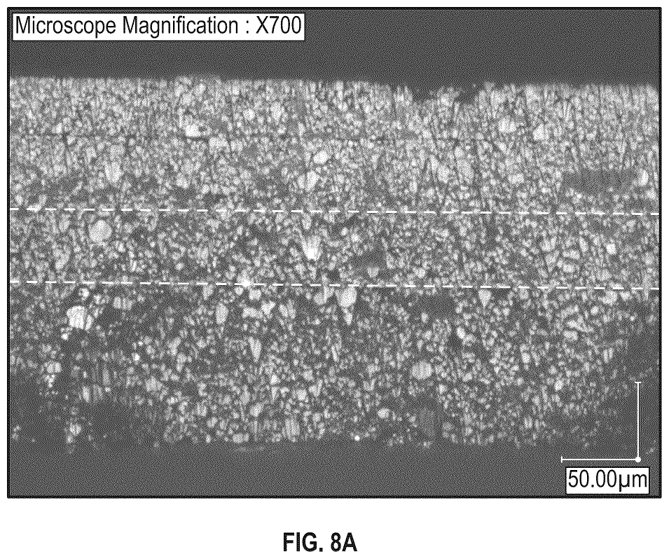

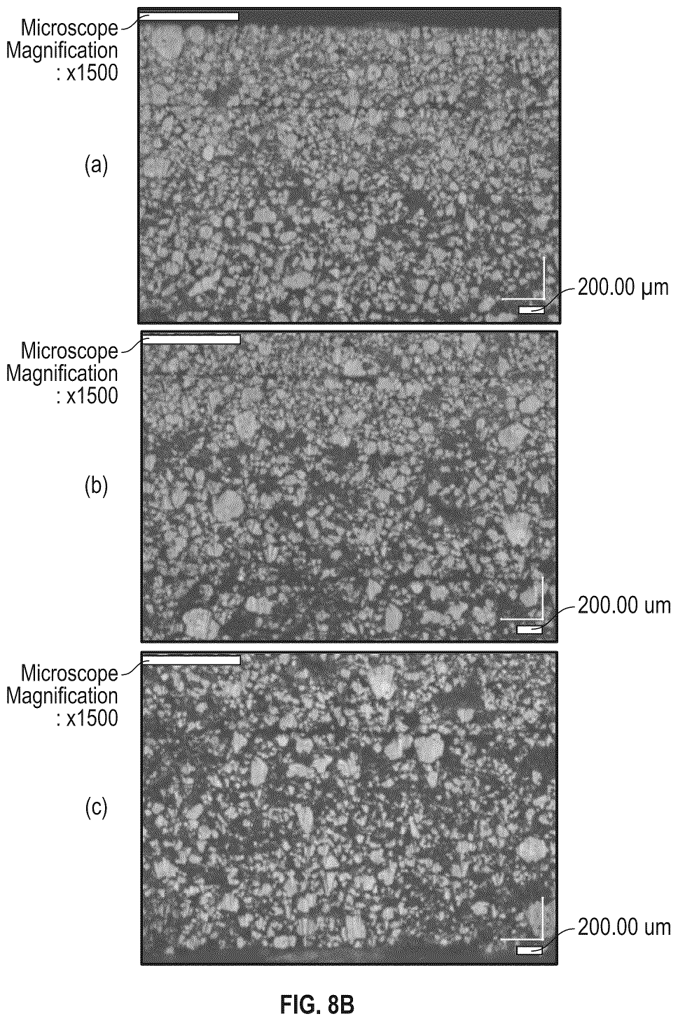

To achieve successful fabrication of an electrode with high theoretical capacity density and suitable for fast rates, electrodes with a gradient of 36% average total porosity were studied. This average porosity is consistent with homogeneous porosity electrodes used commercially and has approximately the same porosity as the thick 34% homogeneous porosity electrodes discussed in the section above. These 34% porosity electrodes will be used as a benchmark. Cross sections of the gradient electrodes are shown in FIGS. 8A and 8B. FIG. 8A is a cross section of a gradient porosity electrode imaged with a digital optical microscope at ×700 magnification, in accordance with some embodiments of the invention. The top of the electrode is 16% porosity and bottom of the electrode is 48% porosity. Dotted green lines indicate the interfaces between 16-34% (top line) and 34-48% (bottom line). FIG. 8B is a cross section of the gradient porosity electrode imaged with digital optical microscope at ×1500 magnification, (a) showing top of the electrode with 16% porosity, (b) showing the middle of the electrode with 34% porosity, and (c) showing the bottom of the electrode with 48% porosity. By observing the quantity of LCO particles in a specific area, a gradient in porosity is clearly seen. The upper portion of the electrode with 16% porosity has a denser array of LCO particles close together while the bottom of the electrode with 48% porosity has noticeably more porosity between LCO particles. This indicates fabrication of the gradient porosity within the electrode was successful and the porosity did not homogenize after lamination.

b. Electrochemical Characterization

For quantifiable evidence of success in fabricating gradient porosity, tortuosity was calculated for the gradient electrodes using EIS. The tortuosity of the gradient electrode with an average porosity of 36% (with the high porosity side towards the electronically insulating layer (e.g., a separator)) was 3.92, while the reverse orientation of gradient porosity had an average tortuosity of 8.19. As expected, homogeneous 34% porosity electrodes had an average tortuosity between those two values of 6.19. Therefore, creating a gradient porosity can modify the tortuosity of an electrode while maintaining the same overall porosity in the electrode.

Effects of the homogeneous versus heterogeneous porosity are also prevalent in their signature curves for capacity density, as seen in FIG. 6A. From 10 C to C/2, 48% porosity had the greatest cumulative capacity density of all the electrodes but falls behind at slower rates due to lack of active material as discussed in the prior section. The use of a gradient electrode with an average porosity of 36%, which is approximately the same porosity as the 34% porosity standard, results in an excellent capacity density at a high rate of 1 C of 0.0149 mAh/μm. This is only 18% less than the 48% porosity electrode at 0.0181 mAh/μm and 54% greater than the benchmark 34% porosity's 0.0097 mAh/μm. In contrast to the 48% porosity electrode and despite having similar excellent high rate performance, the gradient electrode exhibits a high capacity density of 0.03 mAh/μm at low rates as a result of its intrinsically lower porosity. This is a 20% increase in capacity density compared to the 48% porosity and is on par with that of the 34% standard, offering high capacity density at high and low rates, the best of both performance spectrums.

The reverse gradient electrode, with the high porosity portion (48%) oriented towards the current collector and the low porosity portion (16%) towards the electronically insulating layer (e.g., a separator), also with an average porosity of approximately 36%, demonstrates that the porosity gradient, not just the average porosity, is the enabler for this performance. The reverse gradient only had a capacity density of 0.009 mAh/μm at 1 C, unlike the standard gradient's high 0.0149 mAh/μm capacity density. This is a 65.6% increase in capacity density due to switching the gradient orientation alone. Since the gradient and reverse gradient have the same approximate porosity, they have nearly the same capacity density at low rates. Thus, the orientation of the gradient porosity greatly impacts the capacity density at only high rates. This is consistent with the difference in tortuosity of 3.92 and 8.19 for the gradient and reverse gradient electrodes, respectively. In fact, tortuosity was very consistent with the trends in measured rate throughout this study.

The impact of gradient porosity was also clearly demonstrated in the full discharges, as seen in FIG. 7A. At a full discharge of 1 C, the gradient electrode has a comparable average capacity density of 0.0141 mAh/μm compared to 48% porosity's 0.0176 mAh/μm. Even though their average porosities are approximately the same, the gradient electrode's average capacity density is almost double that of 34% porosity's 0.0083 mAh/μm. With only 0.0076 mAh/μm, the reverse gradient's capacity density was 85.5% less than that of the gradient electrode. At C/10 full discharge, 34% porosity, the gradient, and the reverse gradient had comparable average capacity densities of 0.0312,0.0297, and 0.0289 mAh/μm, respectively. Due to its lack of active material, 48% porosity had an average capacity density of only 0.0248 mAh/μm. Therefore, a gradient in porosity with high porosity towards the electronically insulating layer (e.g., a separator) and low porosity towards the current collector provides the benefit of high capacity density at both fast and slow rates.

### Overall results

Thus, the above demonstrates that monolithic thick electrodes greater than 200 μm in thickness with a porosity gradient can clearly provide very significant capacity density improvements at high rates, with over 50% improvement from equivalent porosity homogeneous electrodes, without sacrificing capacity density at low rates. This porosity architecture resolves the challenge of low porosity electrodes granting high capacity density at only low rates, and in contrast, high porosity electrodes only resulting in high energy density at high rates.

By creating a gradient of porosity, ultrathick electrodes were formulated with large capacity densities for both high and low rates. These high performing gradient electrodes had high porosity towards the electronically insulating layer (e.g., a separator) and low porosity towards the current collector, for a total of ˜36% average porosity. At high rates, the gradient electrode had similar capacity densities to homogeneous porosity electrodes with ˜12% more porosity (48% porosity electrodes). Additionally, the gradient electrode was 54% greater in capacity density than homogeneous porosity electrodes of approximate equivalent porosity (34% porosity electrodes) at high rates such as 1 C. For low rates, the gradient electrode had 20% more capacity density than the 48% porosity electrodes and similar capacity density to electrodes with 34% porosity. This indicates that gradient porosity does not impede on the electrode's low rate capacity density. Therefore, gradient porosity provides the high rate capabilities of high porosity electrodes while still retaining the low rate capabilities of low porosity electrodes.

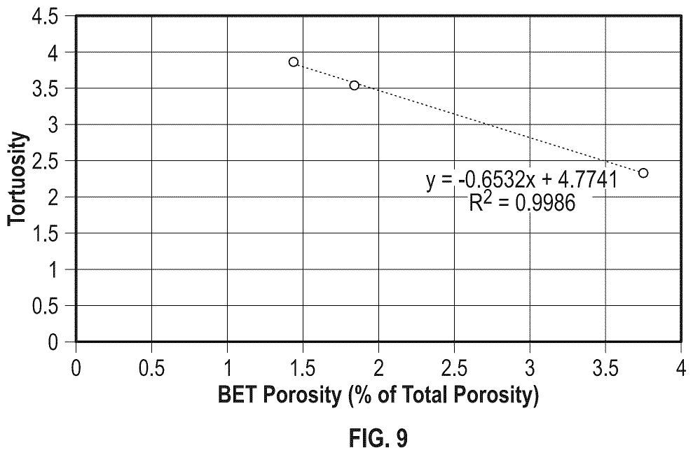

Aside from the distribution of porosity, the BET results indicated that the pore type can also affect transport properties in the electrode. FIG. 9 is a correlation plot of Tortuosity vs BET Porosity for 16%, 34% and 48% porosity electrodes, in accordance with some embodiments of the invention. FIG. 9 displays the strong correlation between tortuosity and BET porosity (0-200 nm). With more BET porosity in the electrode, the tortuosity decreases. Although this correlation only contains three data points, it has a high R2 value of 0.9986.

Additionally, large BET pores greatly improve transport properties in separators, and He ion imaging reveals the intricate BET porosity network within the carbon.

The above demonstrated the great impact of gradient porosity in electrodes with high porosity towards the electronically insulating layer (e.g., a separator) and low porosity towards the current collector and the novel fabrication of such monolithic electrodes. Modeling with finite element analysis (FEA) can provide valuable insight into which porosity distributions are worth pursuing prior to fabrication. Models for gradient porosity have been created previously; however, these models were representing the gradient porosity with a single equation. More realistic models that account for each layer's porosity and thickness within the laminated electrode may provide insight that would be useful for further gradient electrode fabrication.

The above discussion demonstrates very thick gradient porosity electrodes that provide improved high rate capabilities without sacrificing low rate capacity density have been fabricated for lithium batteries. ˜230 μm gradient porosity LiCoO₂ based electrodes with very high 54 mg/cm² loadings and 36% total porosity were fabricated and compared to homogeneous porosity electrodes of equivalent thicknesses and average porosities. Gradient electrodes with an average porosity of 36% with high porosity (48%) towards the electronically insulating layer (e.g., a separator) and low porosity (16%) towards the current collector had a low tortuosity of 3.92. Homogeneous 34% porosity electrodes had a tortuosity of 6.19 and reverse gradient electrodes had a tortuosity of 8.19, thereby showing that porosity distribution had a clear impact on the ionic diffusion through the electrode. At high rates such as 1 C, the capacity densities of the 36% average porosity gradient electrodes approached those of the 48% high homogeneous porosity electrodes and were 54% greater than the homogeneous 34% porosity homogeneous electrodes. At low rates such as C/100, gradient electrodes had a 20% increase in capacity density over 48% porosity electrodes and had equivalent capacity densities to 34% porosity electrodes. Hence, gradient porosity electrodes provide improved high rate capabilities without sacrificing low rate capacity density and are a valuable approach in designing high energy density batteries of the future using thick electrodes.

In some embodiments, a battery comprises: a housing; an electrolyte disposed in the housing; and a first electrode, wherein a porosity of the first electrode varies across a surface of the first electrode.

In some embodiments, the porosity of the first electrode varies in a gradient.

In some embodiments, the first electrode comprises a positive electrode.

In some embodiments, the first electrode comprises a negative electrode.

In some embodiments, the battery further comprises a second electrode, wherein the porosity of the second electrode varies in a gradient.

In some embodiments, the first electrode has a thickness of from 20 to 1000 microns.

In some embodiments, the first electrode has a thickness of from 100 to 300 microns.

In some embodiments, a batter comprises: a positive electrode; a negative electrode; electrolyte; and an electronically insulating layer that contains the electrolyte; and wherein the positive electrode and the negative electrode are stacked vertically, wherein the electronically insulating layer is interposed between the positive electrode and the negative electrode, wherein at least one of the positive electrode and the negative electrode has a porosity in which the electrolyte resides, and wherein the porosity of either or both the positive electrode and the negative electrode varies laterally across a surface thereof.

In some embodiments, the porosity varies continuously in a gradient.

In some embodiments, the porosity varies non-continuously.

In some embodiments, the porosity includes a minimum porosity of 0% to 45%.

In some embodiments, the electronically insulating layer is a solid state ionic conductor.

In some embodiments, the electrolyte is a solid state ionic conductor.

In some embodiments, the porosity includes a maximum porosity of 36% to 90%.

In some embodiments, the porosity is formed by laser radiation.

In some embodiments, the laser radiation is rastered across the surface.

In some embodiments, a battery comprises: at least one current collector; at least one current collector tab; a positive electrode; and a negative electrode, wherein a maximum porosity of at least one of the electrodes is formed laterally closest to the at least one current collector tab, and wherein the maximum porosity decreases systematically away from the at least one current collector.

In some embodiments, at least one electrode has a thickness of 100 to 350 microns.

In some embodiments, at least one electrode has a vertical porosity gradient.

In some embodiments, the battery further comprises an electronically insulating layer, wherein the maximum porosity is adjacent the electronically insulating layer.

In some embodiments, at least one of the electrodes comprises layers of electrode materials having different porosities, wherein the layers are laminated together.

In some embodiments, the maximum porosity is at an interface of at least one of the electrodes and the electronically insulating layer.

In some embodiments, at least one of the electrodes is comprised of a negative or positive active electrode material, a conductive additive, a binder, and a plasticizer.

In some embodiments, the conductive additive is carbon.

In some embodiments, the binder is PVdF-HFP.

In some embodiments, at least one of the electrodes is laminated to at least one of the at least one current collector and the electronically insulating layer.

In some embodiments, a method comprises: obtaining a first electrode having a first predetermined porosity; obtaining a second electrode having a second predetermined porosity, wherein the second predetermined porosity is different than the first predetermined porosity; and laminating the first electrode with the second electrode, thereby providing for an interface free electrode structure with a porosity gradient.

In some embodiments, there are multiple layers and porosities beyond 2.

In some embodiments, a porosity is highest at an interface with an electronically insulating layer.

In some embodiments, a lowest porosity is from 0-45%.

In some embodiments, a highest porosity is from 36%-90%.

In some embodiments, a thickness of the electrode structure is from 50 to 500 microns.

In some embodiments, a thickness of the electrode structure is from 100 to 300 microns.

In some embodiments, at least one of the first electrode and the second electrode comprises a negative or positive active electrode material, a conductive additive, a binder, and a plasticizer to tune a porosity percentage.

In some embodiments, the method further comprises extracting the plasticizer to leave the electrode structure with the porosity gradient.

In some embodiments, the method further comprises laminating the electrode structure to at least one of a current collector and an electronically insulating layer.

In some embodiments, a battery comprises: a housing; an electrolyte disposed in the housing; and a first electrode, wherein the first electrode comprises a plurality electrode layers, wherein the plurality of electrode layers comprises at least a first electrode layer and a second electrode layer, wherein the first electrode layer has a first porosity, wherein the second electrode layer has a second porosity different than the first electrode layer, wherein the first electrode layer and the second electrode layer are laminated to one another to form the first electrode.

In some embodiments, the first electrode comprises a positive electrode.

In some embodiments, the first electrode comprises a negative electrode.

In some embodiments, the battery further comprises a second electrode, wherein a porosity of the second electrode varies in a gradient.

In some embodiments, the first electrode has a thickness of from 20 to 1000 microns.

In some embodiments, the first electrode has a thickness of from 100 to 300 microns.

In some embodiments, the plurality of electrode layers comprises at least a third electrode layer, wherein the second electrode layer is between the first electrode layer and the third electrode layer, wherein a porosity of the first electrode layer is greater than a porosity of the second electrode layer, wherein a porosity of the second electrode layer is greater than a porosity of the third electrode layer.

In some embodiments, a battery comprises: a housing; an electrolyte disposed in the housing; an electronically insulating layer disposed in the housing and containing the electrolyte; a first electrode comprising a positive electrode having a first porosity; a second electrode comprising a negative electrode having a second porosity, wherein the first electrode and the second electrode are separated by the electronically insulating layer which contains the electrolyte, wherein at least one of: the first porosity varies through a thickness of the first electrode, or the second porosity varies through a thickness of the second electrode, and wherein at least one of: an average porosity of the first electrode increases towards an interface of the first electrode and the electronically insulating layer which contains the electrolyte, or an average porosity of the second electrode increases towards an interface of the second electrode and the electronically insulating layer which contains the electrolyte.

In some embodiments, the first electrode comprises a plurality of first electrode layers, wherein the plurality of first electrode layers comprises at least a first electrode layer and a second electrode layer, wherein the first electrode layer has a higher porosity than the second electrode layer, wherein the first electrode layer is bonded to the second electrode layer, wherein the first electrode layer is closer to the interface of the first electrode with the electrolyte.

In some embodiments, the second electrode comprises a plurality of second electrode layers, wherein the plurality of second electrode layers comprises at least a third electrode layer and a fourth electrode layer, wherein the third electrode layer has a higher porosity than the fourth electrode layer, wherein the third electrode layer is bonded to the fourth electrode layer, wherein the third electrode layer is closer to the interface of the second electrode with the electrolyte.

In some embodiments, at least one of the first electrode or the second electrode has a thickness of less than 150 microns.

In some embodiments, at least one of the first electrode or the second electrode has a thickness greater than 200 microns.

In some embodiments, at least one of the first porosity or the second porosity is formed by laser radiation.

In some embodiments, at least one of the first electrode or the second electrode is bonded to the electronically insulating layer.

In some embodiments, the first porosity of the first electrode varies in a gradient.

In some embodiments, the first electrode comprises a positive electrode.

In some embodiments, the first electrode comprises a negative electrode.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms, without altering their respective meanings as defined herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

What is claimed is:

1. A battery, comprising:
a housing;
an electrolyte disposed in the housing; and
a first electrode,
wherein a first porosity of the first electrode varies across a first surface of the first electrode.

2. The battery of claim 1, wherein the first porosity of the first electrode varies in a gradient across the first surface.

3. The battery of claim 1, wherein the first electrode is a positive electrode or a negative electrode.

4. The battery of claim 2, further comprising a second electrode, wherein a second porosity of the second electrode varies in a gradient across a second surface of the second electrode.

5. The battery of claim 4, wherein the first electrode includes a plurality of first electrode layers, and wherein the first porosity of each of the plurality of first electrode layers is different from one another.

6. The battery of claim 5, wherein each of the plurality of first electrode layers is laminated to one another.

7. The battery of claim 5, further comprising an electronically insulating layer disposed in the housing and containing the electrolyte.

8. The battery of claim 7, wherein the first electrode and the second electrode are stacked vertically, wherein the electronically insulating layer is interposed between the first electrode and the second electrode, wherein the electrolyte resides in at least one of the first porosity of the first electrode and the second porosity of the second electrode, and wherein at least one of the first porosity of the first electrode and the second porosity of the second electrode varies laterally across the first surface of the first electrode and the second surface of the second electrode.

9. The battery of claim 8, wherein the first electrode is bonded to the electronically insulating layer.

10. The battery of claim 8, wherein the first electrode includes a positive electrode, wherein the second electrode includes a negative electrode, wherein at least one of: the first porosity varies through a thickness of the first electrode, the second porosity varies through a thickness of the second electrode, and wherein at least one of an average porosity of the first porosity of the first electrode increases towards an interface of the first electrode and the electronically insulating layer, and an average porosity of the second porosity of the second electrode increases towards an interface of the second electrode and the electronically insulating layer which contains the electrolyte.

11. The battery of claim 8, wherein the plurality of first electrode layers includes at least a first electrode layer and a second electrode layer, wherein the first electrode layer has a higher porosity than the second electrode layer, wherein the first electrode layer is bonded to the second electrode layer, and wherein the first electrode layer is closer to an interface of the first electrode with the electrolyte.

12. The battery of claim 11, wherein the second electrode includes a plurality of second electrode layers, wherein the plurality of second electrode layers includes at least a third electrode layer and a fourth electrode layer, wherein the third electrode layer has a higher porosity than the fourth electrode layer, wherein the third electrode layer is bonded to the fourth electrode layer, wherein the third electrode layer is closer to the interface of the second electrode with the electrolyte.

13. The battery of claim 1, wherein the first electrode includes a negative or positive active electrode material, a conductive additive, a binder, and a plasticizer.

14. A battery, comprising:
at least one current collector;
at least one current collector tab;
a positive electrode; and
a negative electrode,
wherein each of the positive electrode and the negative electrode has a porosity,
wherein a maximum porosity of the porosity of at least one of the positive electrode and the negative electrode is formed laterally closest to the at least one current collector tab, and
wherein the maximum porosity decreases systematically away from the at least one current collector.

15. The battery of claim 14, wherein at least one of the positive electrode and the negative electrode includes a plurality of electrode layers, and wherein the porosity of each of the plurality of electrode layers is different from one another.

16. The battery of claim 15, wherein the plurality of electrode layers are laminated to one another.

17. The battery of claim 16, wherein the plurality of electrode layers includes a first electrode layer, a second electrode layer, and a third electrode layer, wherein the second electrode layer is between the first electrode layer and the third electrode layer, wherein the porosity of the first electrode layer is greater than the porosity of the second electrode layer, and wherein the porosity of the second electrode layer is greater than the porosity of the third electrode layer.

18. A method, comprising:
obtaining a first electrode having a first predetermined porosity;
obtaining a second electrode having a second predetermined porosity,
wherein the second predetermined porosity is different than the first predetermined porosity; and
laminating the first electrode with the second electrode to provide an electrode structure with a porosity gradient.

19. The method of claim 18, wherein at least one of the first electrode and the second electrode includes a plasticizer, and wherein the method further comprises extracting the plasticizer to leave the electrode structure with the porosity gradient.

20. The method of claim 19, further comprising laminating the electrode structure to at least one of a current collector and an electronically insulating layer.
